(19) United States
(12) Patent Application Publication
(10) Pub. No.: US 2026/0170079 A1
(43) Pub. Date: Jun. 18, 2026

(54) METHOD AND DEVICE FOR PERFORMING CONVOLUTION OPERATION

(71) Applicant: DESIGNEDAI CO.,LTD., Hwaseong-si (KR)

(72) Inventor: Jaemo SUNG, Hwaseong-si (KR)

(73) Assignee: DESIGNEDAI CO.,LTD., Hwaseong-si (KR)

(21) Appl. No.: 19/324,574

(22) Filed: Sep. 10, 2025

(30) Foreign Application Priority Data
Dec. 13, 2024 (KR) 10-2024-0186085
Mar. 10, 2025 (KR) 10-2025-0030306

(51) Int. Cl. G06F 17/15

(52) U.S. Cl. CPC G06F 17/15

(57) ABSTRACT

The present disclosure according to at least one embodiment provides a method for performing a convolution operation. The method comprises dividing a filter of a convolution operation having a spatial domain size H_{F}×W_{F} into unit filters, while traversing a spatial domain of an input tensor of the convolution operation from an initial position thereof, repeating: i) obtaining an input patch having a size of H_{O}×W_{O} at a current position according to a result of the traversing, and ii) obtaining an output tensor corresponding to each unit filter as a result of a convolution operation between the obtained input patch and a unit filter of a position corresponding to a position of the obtained input patch, and accumulating the obtained output tensors respectively corresponding to the unit filters, thereby generating the output tensor of the convolution operation.

### CROSS-REFERENCE TO RELATED APPLICATION

This application claims priority from Korean Patent Application No. 10-2024-0186085 filed on Dec. 13, 2024 and Korean Patent Application No. 10-2025-0030306 filed on Mar. 10, 2025 in the Korean Intellectual Property Office, and all the benefits accruing therefrom under 35 U.S.C. 119, the contents of which in its entirety are herein incorporated by reference.

### BACKGROUND

### Field

The present disclosure relates to a method and device for performing a convolution operation, and more particularly, to a method and device for performing a convolution operation using a matrix multiplication operation.

### Description of Related Art

A convolution operation is an operation scheme commonly used in face recognition, image classification, natural language processing, etc. in deep learning and artificial neural network fields, or commonly used in image filtering, edge detection, object recognition, image segment, etc. in computer vision fields. In addition, the convolution operation is widely used in various fields such as signal processing, pattern recognition and object tracking, audio and image compression, and medical image analysis.

Referring to FIGS. 1 and 2, a conventional convolution operation is one of tensor operations for generating an output tensor O from an input tensor I and a filter tensor F, and is defined as Mathematical Formula 10 of FIG. 1, and in this case, a stride and a dilation may be included as parameters for adjusting an execution manner of the convolution operation. Each of the input tensor I, the output tensor O, and the filter tensor F of the convolution operation may be a four-dimensional tensor having a data format 11 composed of a channel size C, a height H and a width W of a spatial domain, or a batch size N of each tensor. (Hereinafter, a definition of mathematical terms described herein will be described with reference to FIG. 37).

In FIG. 1, a specific element value of the output tensor O[c_{O}, h_{O}, w_{O}, n] refers to an output value of the convolutional operation of a c_{O}-th second output channel at a spatial position of (h_{O},w_{O}) on a n-th data sample, and is defined as an accumulated multiply and add operation 12 obtained by summing products of the element values of the input tensor and the filter tensor. In this regard, the spatial position (h_{F},w_{F}) of the input tensor I corresponding to the spatial position (h_{I},w_{I}) of the filter tensor F may be defined based on Mathematical Formula 13 using a stride parameter (H_{S},W_{S}).

In the conventional convolution operation, as shown in FIG. 3, a convolution operation is performed using a sliding window approach in which a data patch having a size of the filter tensor F is moved in a horizontal or vertical direction in the spatial domain of the input tensor I.

The conventional convolution operation as described above may be implemented using a loop-based algorithm using multiple nested loops in the most basic form. In this regard, in an example, the 7-nested loops convolution operation algorithm 50 of FIG. 4 may be used. The convolution operation of an input tensor 51 and a filter tensor 52 may be performed using such a loop-based algorithm as in an example of FIG. 5, and as a result, an output tensor 53 may be generated. In this regard, in FIG. 5, i^{[c]} corresponding to each cell of the input tensor 51 means all of C₁ element values at a spatial position of (C_{I},w_{I}), and f^{[cc]} corresponding to each cell of the filter tensor 52 means all of C_{O}×C_{I} element values on which a convolution operation is performed with respect to each cell of the input tensor 51 at a spatial position (h, w_{f}). In addition, o^{[c]} corresponding to each cell of the output tensor 53 means all of C_{O} element values at the spatial position of (h_{O},w_{O}).

The 7-nested loops convolution operation algorithm 50 traverses the filter tensor 52 and the input tensor 51 through an independent loop per each dimension. It is easy to understand the 7-nested loops convolution operation algorithm, easy to implement the 7-nested loops convolution operation algorithm, and the 7-nested loops convolution operation algorithm does not require additional memory. However, the 7-nested loops convolution operation algorithm exbibits very low operation speed performance in actual applications and memory access is inefficient because a plurality of memory accesses occur per each loop during the operation. In addition, the 7-nested loops convolution operation algorithm is basically premised on sequential operations, such that it is difficult to apply parallelization thereto. It is difficult to recycle data in the 7-nested loops convolution operation algorithm such that an amount of an unnecessary operation increases such that performance thereof is deteriorated.

Further, in another scheme of performing the convolution operation, a IM2COL-based convolution operation algorithm 60 of FIG. 6 may be used. The IM2COL-based convolution operation algorithm 60 refers to a scheme of reconstructing the input data to convert a convolution operation 61 using four-dimensional tensors into a two-dimensional matrix multiplication operation 62. A General Matrix-Matrix Multiplication (GEMM) matrix multiplication module as a component of an optimized Basic Linear Algebra Subprograms (BLAS) library may be utilized in the IM2COL-based convolution operation algorithm 60.

As in an example of FIG. 7, using the IM2COL-based convolution operation algorithm 60, the input tensor 51 (see FIG. 5) is converted into a two-dimensional input matrix 72, and the filter tensor 52 (see FIG. 5) is converted into a two-dimensional filter matrix 71, and then, a matrix multiplication operation of the input matrix 72 and the filter matrix 71 is performed, and as a result, a two-dimensional output matrix 73 may be generated. The two-dimensional output matrix 73 generated in this way may be converted into a four-dimensional output tensor again to generate a final output tensor 53 (see FIG. 5).

The IM2COL-based convolution operation algorithm 60 converts the convolution into the matrix multiplication, thereby improving an operation speed using the optimized BLAS library and facilitating parallel processing in a hardware manner. However, in the IM2COL-based convolution operation algorithm 60, the memory usage is increased because the input data is unfolded into a large matrix, and the redundancy of data in the converted matrix is increased because the patches of the convolution are duplicate with each other. In addition, the memory efficiency is deteriorated due to the duplicate data and an additional operation is required in the conversion process, such that a total operation time is increased and the complexity of the system is increased. Therefore, it is very inefficient to use the IM2COL-based convolution operation algorithm 60 in an environment with limited memory and computing resources, such as mobile and embedded systems.

Therefore, in performing the convolution operation, there is a need for a scheme capable of remarkably overcoming the disadvantages such as the data duplication and the inefficient memory use while maintaining the advantages of the conventional IM2COL-based convolution operation.

### SUMMARY

A technical purpose to be achieved by the present disclosure is to provide a method and device for performing a convolution operation capable of remarkably improving an operation speed via a sub convolution or matrix multiplication operation using a minimum sized unit filter when performing the convolution operation.

Another technical purpose to be achieved by the present disclosure is to provide a method and device for performing a convolution operation capable of providing a data packing scheme in which data may be consecutively stored in a memory so that an GEMM-based matrix multiplication operation may be performed when performing the convolution operation.

Still another technical purpose to be achieved by the present disclosure is to provide a method and device for performing a convolution operation capable of providing a data packing scheme capable of remarkably reducing memory usage via memory reuse and data deduplication when performing the convolution operation.

Still yet another technical purpose to be achieved by the present disclosure is to provide a method and device for performing a convolution operation capable of performing efficient parallel operation processing in various hardware environments via partitioning when performing the convolution operation.

Still yet another technical purpose to be achieved by the present disclosure is to provide a method and device for performing a convolution operation capable of effectively performing the convolution operation even in an environment in which memory and operation resources are limited, such as a mobile and embedded system.

The technical purposes of the present disclosure are not limited to the above-mentioned technical purposes, and other technical purposes not mentioned may be clearly understood by a person skilled in the art of the present disclosure from the following description.

According to an aspect of the present disclosure, there is provided a method for performing a convolution operation, the method being performed by a computing system. The method comprises dividing a filter of a convolution operation having a spatial domain size H_{F}×W_{F} into a plurality of unit filters, each unit filter having a spatial domain size of 1×1, wherein each of H_{F} and W_{F} is a natural number of 2 or greater, while traversing a spatial domain of an input tensor of the convolution operation from an initial position thereof, repeating: i) obtaining an input patch having a size of H_{O}×W_{O} at a current position according to a result of the traversing, wherein W_{O} is a width of a spatial domain of an output tensor of the convolution operation, and H_{O} is a height of the spatial domain of the output tensor of the convolution operation, and ii) obtaining an output tensor corresponding to each unit filter as a result of a convolution operation between the obtained input patch and a unit filter of a position corresponding to a position of the obtained input patch, and accumulating the obtained output tensors respectively corresponding to the unit filters, thereby generating the output tensor of the convolution operation.

In some embodiments, coordinates on a spatial domain of an initial element of the input patch may be the same as coordinates on the spatial domain of the unit filter defined within the spatial domain of the filter of the convolution operation.

In some embodiments, the traversal may have a stride of a size 1.

In some embodiments, the dividing of the filter may include: when a dilation of the convolution operation is 2 or greater, generating a dilated filter using the filter of the convolution operation, and dividing the dilated filter into the plurality of unit filters.

In some embodiments, the repeating of the i) and the ii) may include: obtaining the input patch in a tensor packing region on a memory of the computing system, wherein the tensor packing region is different from and non-duplicate with a memory region into which the input tensor of the convolution operation has been loaded, wherein data of the input patch is loaded into from a start address to a memory address consecutive thereto in the tensor packing region in a form of a packed tensor.

In some embodiments, the convolution operation may be performed using a GEMM operation of a basic linear algebra subprograms (BLAS) library.

In some embodiments, the obtaining of the input patch may include: obtaining new packing target data according to the traversal from the memory region into which the input tensor has been loaded, and packing the new packing target data into the tensor packing region.

In some embodiments, the tensor packing region may be a buffer region having a size of D_{size}C_{I}(H_{O}(W_{O}N+W_{margin})+H_{margin}), wherein D_{size} denotes a memory size of a data element, and H_{margin}=H_{F}−1 and W_{margin}=W_{F}−1, wherein H_{F} denotes a height on a spatial domain of a filter of the convolution operation, and W_{F} denotes a width on the spatial domain of the filter of the convolution operation.

In some embodiments, the repeating of the i) and the ii) may include: constructing a plurality of parallel processing tasks, based on at least one of dividing an batch size of the convolution operation into a plurality of first partitions, dividing a spatial domain height of the output tensor of the convolution operation into a plurality of second partitions, dividing a spatial domain width of the output tensor of the convolution operation into a plurality of third partitions, and dividing an output channel of the convolution operation into a plurality of fourth partitions, and performing some of the plurality of parallel processing tasks using a first operation means, and performing the others of the plurality of parallel processing tasks using a second operation means.

According to an aspect of the present disclosure, there is provided a method for performing a convolution operation, the method being performed by a computing system. The method comprises while traversing a spatial domain of an input tensor of a convolution operation from an initial position thereof, obtaining an input patch having a size H_{O}×W_{O} at each position according to a result of the traversing, wherein the spatial domain of the input tensor has H_{I}×W_{I}, wherein each of H_{I} and W_{I} is a natural number of 1 or greater, wherein W_{O} denotes a width of a spatial domain of an output tensor of the convolution operation, and H_{O} denotes a height of the spatial domain of the output tensor of the convolution operation, wherein the input patch is obtained from a tensor packing region on a memory of the computing system, obtaining new packing target data non-duplicate with data of an input patch obtained at a previous traversal from a memory region into which the input tensor has been loaded, at each position according to a result of the traversing, and packing the new packing target data into the tensor packing region, wherein the tensor packing region is different from and non-duplicate with the memory domain into which the input tensor of the convolution operation has been loaded, wherein the data of the input patch is loaded into from a start address to an address consecutive thereto in the tensor packing region in a form of a packed tensor.

According to an aspect of the present disclosure, there is provided a method for performing a convolution operation, the method being performed by a computing system. The method comprises converting a convolution operation having a stride of 2 or greater into a plurality of sub-convolution operations, each sub-convolution operation having a stride of 1, dividing a sub-filter of one of the sub-convolution operations having a spatial domain size H_{F}×W_{F} into a plurality of unit filters, each unit filter having a spatial domain size of 1×1, wherein each of H_{F} and W_{F} is a natural number of 2 or greater, while traversing a spatial domain of a sub-input tensor of the one of the sub-convolution operations from an initial position thereof, repeating: i) obtaining an input patch having a size of H_{O}×W_{O} at a current position according to a result of the traversing, wherein W_{O} is a width of a spatial domain of an output tensor of the one of the sub-convolution operations, and H_{O} is a height of the spatial domain of the output tensor of the one of the sub-convolution operations, and ii) obtaining an output tensor corresponding to each unit filter as a result of a convolution operation between the obtained input patch and a unit filter of a position corresponding to a position of the obtained input patch, accumulating the obtained output tensors respectively corresponding to the unit filters, thereby generating the output tensor of the one of the sub-convolution operations, repeating the dividing of the filter, the repeating of the i) and ii), and the generating of the output tensor, on each of the remaining sub-convolution operations, and summing the output tensors of all of the sub-convolution operations to generate an output tensor of the convolution operation.

In some embodiments, the plurality of sub-convolution operations may have respective sub-filters having different spatial domain sizes.

In some embodiments, each of the plurality of sub-convolution operations may have a sub-input tensor having a size corresponding to the spatial domain size of the sub-filter, wherein the size of the sub-input tensor is determined based on the spatial domain size of the sub-filter such that a spatial domain size of the output tensor of the sub-convolution operation is equal to a spatial domain size of the output tensor of the convolution operation.

In some embodiments, a sub-filter of each of the plurality of sub-convolution operations may be non-duplicate with a sub-filter of each of the other sub-convolution operations on a spatial domain of a filter of the convolution operation, wherein a sub-input tensor of each of the plurality of sub-convolution operations is non-duplicate with a sub-input tensor of each of the other sub-convolution operations on a spatial domain of an input tensor of the convolution operation.

Specific features of other embodiments are included in the detailed description and drawings.

### BRIEF DESCRIPTION OF DRAWINGS

The above and other aspects and features of the present disclosure will become more apparent by illustrating in detail embodiments thereof with reference to the attached drawings, in which:

FIGS. 1 to 3 are diagrams for illustrating a convolution operation according to the prior art;

FIGS. 4 and 5 are diagrams for illustrating a 7-nested loops convolution operation algorithm according to the prior art;

FIGS. 6 and 7 are diagrams for illustrating an IM2COL-based convolution operation algorithm according to the prior art;

FIG. 8 is an example of a memory storage structure via a column-major layout scheme of multidimensional tensor data;

FIG. 9 is an example of setting a packed-tensor whose elements are stored in a memory in a column-major layout scheme;

FIG. 10 is a diagram illustrating a Mathematical Formula of a convolution operation using a unit filter according to an embodiment of the present disclosure;

FIG. 11 is a flowchart illustrating a method for performing a convolution operation according to an embodiment of the present disclosure;

FIG. 12 is a flowchart illustrating a method for performing a convolution operation according to another embodiment of the present disclosure.

FIG. 13 is an example for illustrating a unit filter according to some embodiments of the present disclosure;

FIG. 14 is an example illustrating a unit filter to be subject to a matrix multiplication operation and a position of an input patch corresponding to the unit filter according to some embodiments of the present disclosure;

FIG. 15 is an example of dividing a convolution operation in which a stride is greater than 1 into a plurality of sub-convolution operations in which a stride is 1 in each of the plurality of sub-convolution operations, and performing each of the sub-convolution operations, according to some embodiments of the present disclosure;

FIG. 16 is a diagram illustrating a Mathematical Formula defining each sub-filter used in each of a plurality of sub-convolution operations according to some embodiments of the present disclosure;

FIG. 17 is a diagram illustrating a Mathematical Formula corresponding to the embodiment as described using FIG. 15;

FIG. 18 is an example of generating a dilation filter tensor when a dilation is greater than 1 according to some embodiments of the present disclosure;

FIG. 19 is a diagram illustrating a Mathematical Formula of a convolution operation using a matrix multiplication operation of a unit filter and an input patch according to some embodiments of the present disclosure;

FIG. 20 is an example illustrating a domain of an input tensor in which redundant data reference occur in a convolution operation according to some embodiments of the present disclosure;

FIGS. 21 to 23 are examples illustrating a data packing method for a GEMM-based matrix multiplication operation according to some embodiments of the present disclosure;

FIG. 24 is an example illustrating a data packing method having a traversal direction different from that of the example described in FIGS. 21 to 23;

FIG. 25 is a diagram illustrating a Mathematical Formula for calculating a size of a memory buffer for data packing and memory usage efficiency according to some embodiments of the present disclosure;

FIG. 26 is an example of partitioning for parallelization according to some embodiments of the present disclosure;

FIGS. 27 to 35 show various embodiments of a convolution operation algorithm according to some embodiments of the present disclosure;

FIG. 36 is an example illustrating a hierarchical structure diagram of a device for performing a convolution operation for implementing an embodiment of the present disclosure;

FIG. 37 is a hardware configuration diagram of an example computing system that may implement methods according to an embodiment of the present disclosure; and

FIG. 38 is a table showing definitions of terms used in Mathematical Formulas according to some embodiments of the present disclosure.

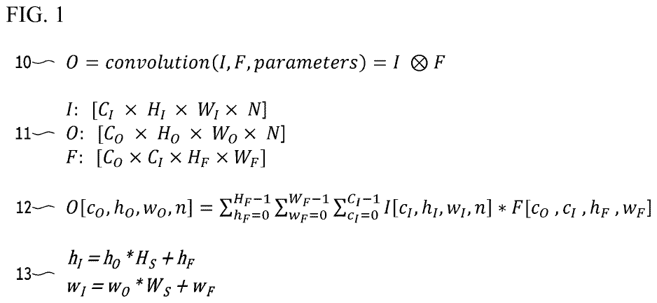

### DETAILED DESCRIPTIONS

Hereinafter, preferred embodiments of the present disclosure will be described with reference to the attached drawings. The advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Hereinafter, some embodiments of the present disclosure will be described in detail with reference to the accompanying drawings.

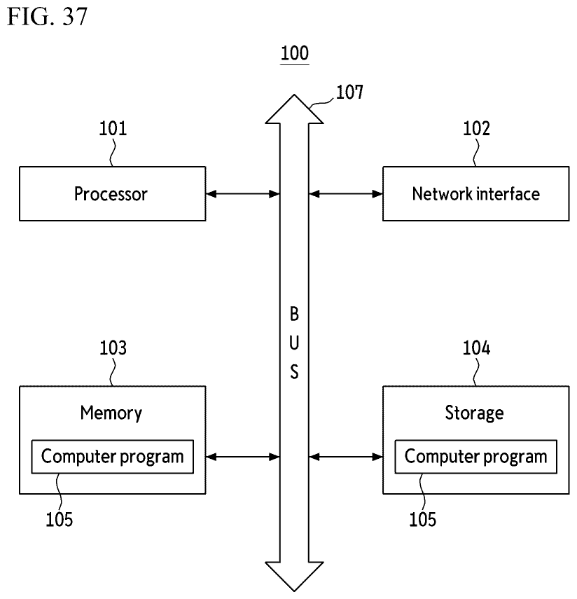

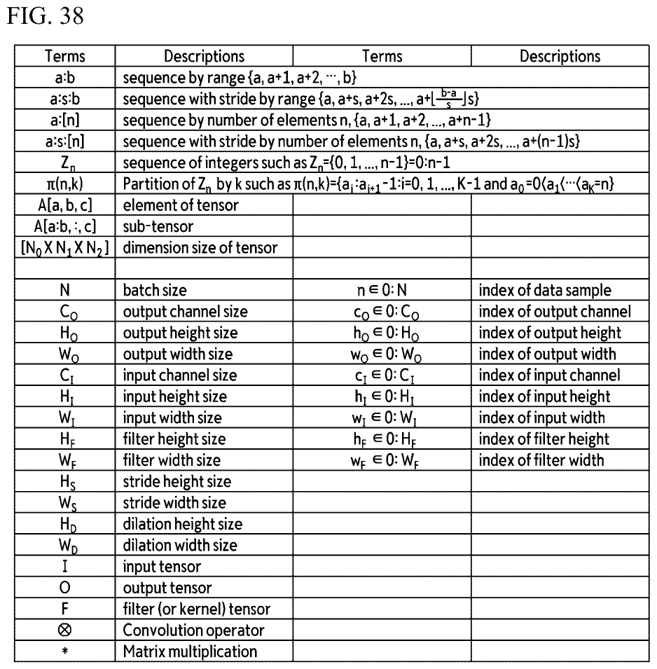

Hereinafter, in describing the method for performing the convolution operation according to an embodiment of the present disclosure, definitions of terms used in the Mathematical Formula described herein may refer to FIG. 37.

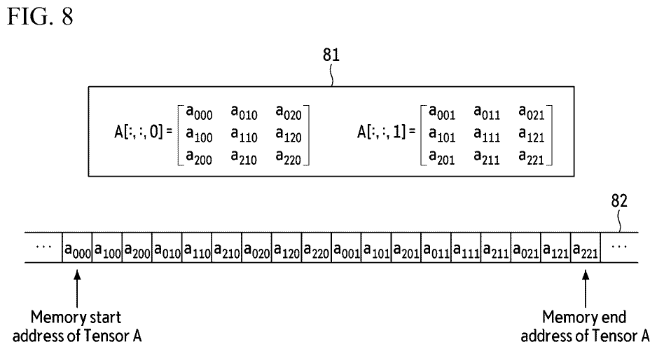

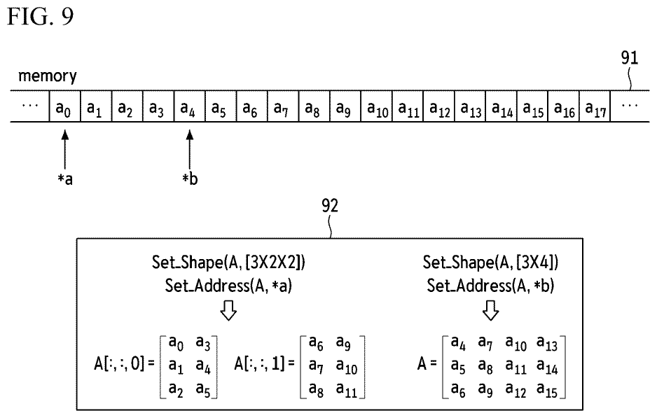

First, before describing the method for performing the convolution operation according to an embodiment of the present disclosure, a basic construction of a memory storage structure to be used in an embodiment of the present disclosure will be described with reference to FIGS. 8 and 9.

Referring to FIG. 8, a memory storage structure of multidimensional tensor data according to an embodiment of the present disclosure may comply with a column-major layout scheme. As in the illustrated example, the column-major layout scheme is a scheme in which in storing a multi-dimensional tensor data A 81 having a size of [3×3×2] in a memory 82, a column is preferentially disposed in a consecutive space of a memory 82. In this regard, all rows of a first column is consecutively stored in the memory 82, and then, all rows of a second column is consecutively stored in the memory 82.

When a tensor consecutively stored in the memory is defined as a packed tensor, a packed tensor A may be defined by setting 92 a position Set_Address in the memory 91 of element data stored in the memory 91, and a shape Set_Shape thereof as in the example of FIG. 9.

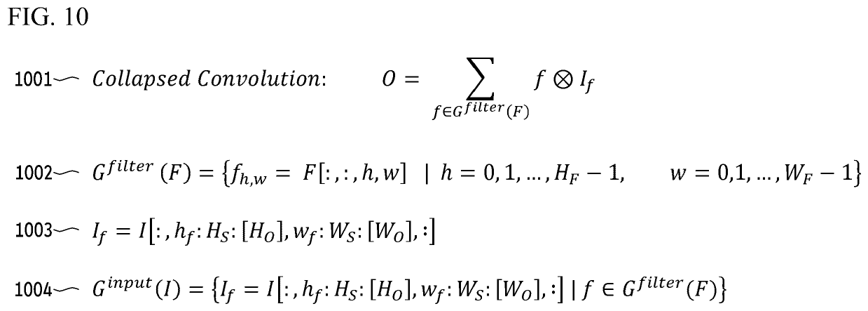

FIG. 10 is a diagram illustrating a Mathematical Formula of a convolution operation using a unit filter according to an embodiment of the present disclosure.

First, a set of unit filters f obtained by dividing F: [C_{O}×C_{I}×H_{F}×W_{F}] as a four-dimensional filter tensor into the unit filters f having a form of [C_{O}×C_{I}×1×1] defined at one point of a spatial domain having a size of H_{F}×W_{F} is defined as G^{filter} (F) 1002 (where C_{I} denotes the size of the input channel, C_{O} denotes the size of the output channel, H_{F} denotes the height of the filter, and W_{F} denotes the width of the filter).

In addition, a sub-input tensor of the input tensor I with a size of [C_{I}×H_{O}×W_{O}×N] and each unit filter f are subject to the convolution operation. In this regard, the sub-input tensor is defined as I_{f} 1003 (where H_{O} is an output height, Weis an output width, and N is a batch size). Further, the set of all of the sub-input tensors I_{f} for f∈G^{filter} is defined as G^{input}(I) 1004.

In this regard, the convolution operation (also referred to as the Collapsed Convolution operation) according to an embodiment of the present disclosure is performed in a manner of cumulatively summing the results obtained by performing the convolution operation of each unit filter f and the sub-input tensor I_{f} for all unit filters f, as in a Mathematical Formula 1001 of FIG. 10.

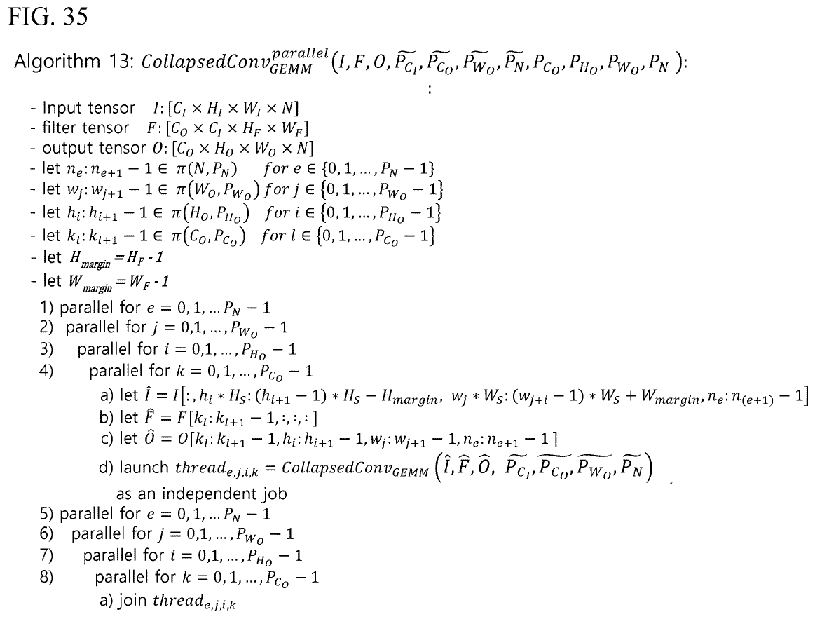

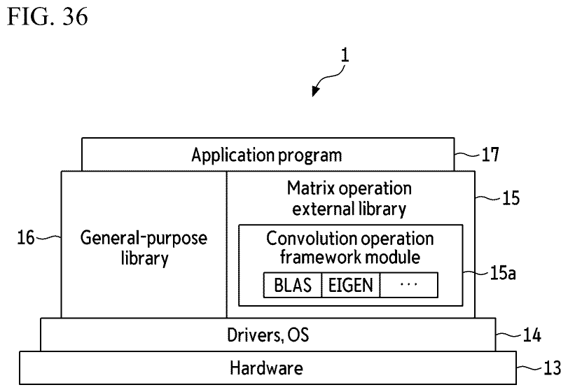

The convolution operation according to an embodiment of the present disclosure may be performed by a computing system 100 illustrated in FIG. 36. The computing system 100 may be, for example, the device 1 for performing the convolution operation having a hierarchical structure illustrated in FIG. 35.

Referring to FIG. 35, the device 1 for performing the convolution operation has a hierarchical structure including hardware 13, a driver/operating system 14, a convolution operation framework module 15, a general-purpose library 16, and an application program 17. In this regard, the application program 17 links the general-purpose library 16 and the convolution operation framework module 15 to each other or includes the general-purpose library 16 and the convolution operation framework module 15 as a portion of a program code, controls the driver/operating system 14 using the general-purpose library 16 or the convolution operation framework module 15, and ultimately utilizes the operation resources of the hardware 13.

In an embodiment, the application program 17 may include at least some routines of the convolution operation framework module 15 at a compile-time. That is, the convolution operation framework module 15 may be implemented using a template metaprogramming technique. In this regard, a compiler may include only a routine required for the application program 17 among all routines of the convolution operation framework module 15 in a binary of the application program 17.

In order that the compiler of the application program 17 may determine a routine to be included in the binary of the application program 17 among the routines of the convolution operation framework module 15 at the compile-time, each routine of the convolution operation framework module 15 is implemented in the form of each template, each template includes an execution code of the routine, and each template may be written in a header file. Accordingly, a developer of the application program 17 may apply the method for performing the convolution operation according to the embodiments of the present disclosure only by composing the source code including the header file.

In an embodiment, the convolution operation framework module 15 includes a matrix operation external library 15a that provides routines of the matrix operation, so that when a specific operation is included in the matrix representation, not only the routine implemented by the convolution operation framework module 15 by itself but also the routine included in the matrix operation external library 15a is used as the routine of the specific operation. For example, in the matrix multiplication operation, the routine implemented by the convolution operation framework module 15 by itself may be selected by the convolution operation framework module 15, or the general matrix-matrix multiplication (GEMM) routine of the BLAS library may be selected by the convolution operation framework module 15.

The matrix operation framework module 15 is not limited to being implemented as a software logic, and may be implemented using a hardware chip including an operation means such as a field programming gate array (FPGA) and a system-on-chip (SoC) as a hardware unit for executing each functional unit.

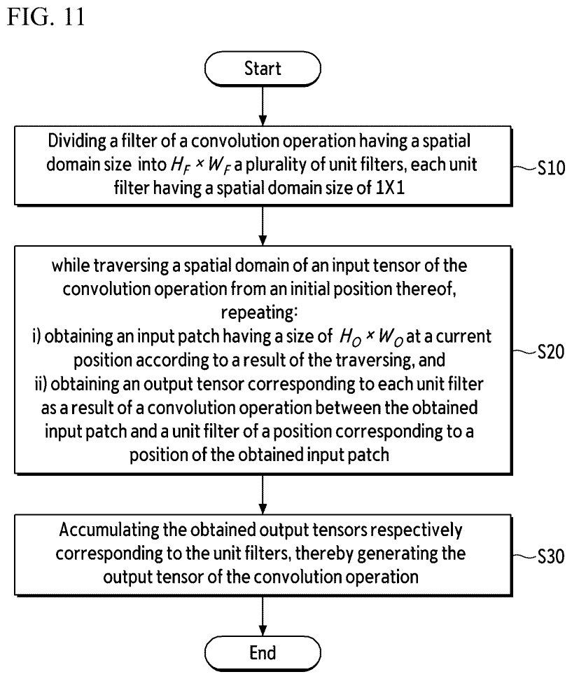

FIG. 11 is a flowchart illustrating a method for performing a convolution operation according to an embodiment of the present disclosure.

The method for performing the convolution operation according to an embodiment of the present disclosure may be executed by the computing system 100 as illustrated in FIG. 36. The computing system 100 may be, for example, the device for performing the convolution operation 1 illustrated in FIG. 35. The computing system 100 for executing the method according to the present embodiment may be a computing device having an application program execution environment. The computing system 100 may be, for example, a device capable of performing an operation function, such as a PC, a server, a laptop computer, and a smartphone.

It should be noted that the description of a subject of performing each of some operations included in the method according to embodiments of the present disclosure may be omitted, and in such a case, the subject is the computing system 100.

According to an embodiment of the present disclosure as described below, performing an GEMM-based matrix multiplication operation using the unit filter for the convolution operation may allow the operation speed to be remarkably increased, and allow the memory efficiency to be improved via the data deduplication and the memory reuse.

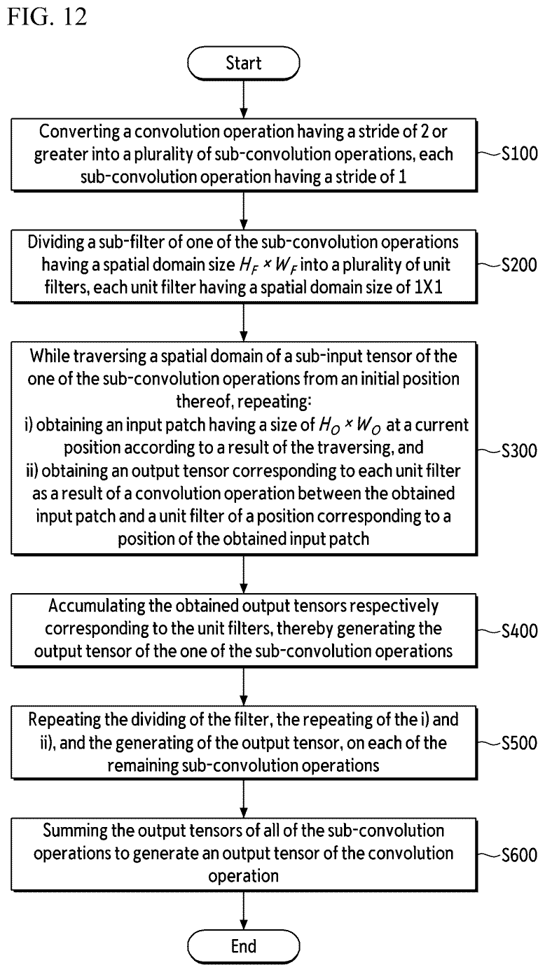

Hereinafter, operations S10 to S30 correspond to a case in which the stride of the convolution operation is 1 (H_{S}=W_{S}=11). A case in which the stride is greater than 1 (H_{S}>1 or W_{S}>1) will be separately described with reference to FIG. 12.

First, in operation S10, the computing system 100 divides a filter of a convolution operation in which a size of a spatial domain is H_{F}×W_{F} (each of H_{F} and W_{F} is a natural number of 2 or greater) into a plurality of unit filters, each having a spatial domain size of 1×1. However, when the size of the spatial domain is 1×1, this size itself corresponds to the size of the spatial domain of the unit filter. Thus, in this case, a next operation S20 is performed without the dividing process.

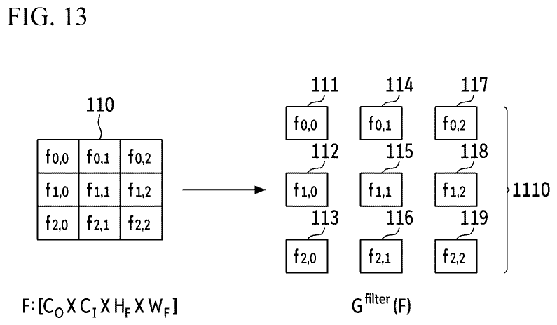

For example, referring to FIG. 13, the computing system 100 may divide the filter tensor F 110 having a size of [C_{O}×C_{I}×H_{F}×W_{F}] into the unit filters 111, 112, 113, 114, 115, 116, 117, 118, and 119, each having a size of [C_{O}×C_{I}×1×1]. In this regard, a set 1110 of the unit filters 111, 112, 113, 114, 115, 116, 117, 118, and 119 may be defined as G^{filter} (F).

In describing the method according to the embodiment of the present disclosure, a basic example in which the dilation of the convolution operation is 1 (H_{D}=W_{D}=1) will be described. However, when the dilation is greater than 1 (H_{D}>1 or W_{D}>1), the spatial domain of the filter is expanded in proportion to the dilation size.

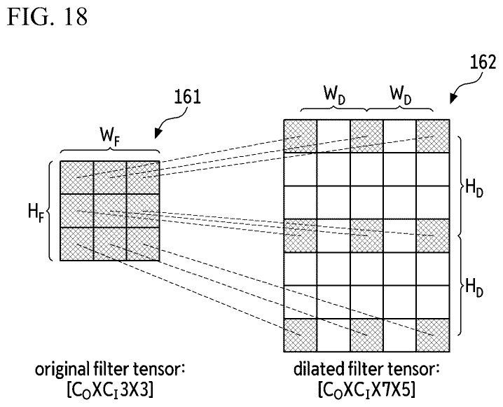

That is, in operation S10, when the dilation of the convolution operation is 2 or greater, the computing system 100 may generate a dilated filter using the filter of the convolution operation, and may divide the dilated filter into a plurality of unit filters. For example, referring to FIG. 18, when the dilation of the convolution operation is 2 or greater (H_{D}=3, W_{D}=2), a conversion of extending the spatial domain of the filter tensor 161 having the size of [C_{O}×C_{I}×3×3] to the dilated filter tensor 162 having the size [C_{O}×C_{I}×7×5] using the dilation size may be performed. In this regard, the computing system 100 may divide the converted dilated filter tensor 162 into the unit filter having a size of [C_{O}×C_{I}×1×1].

In addition, in the dilution filter tensor 162, all elements other than the original filter tensor 161 are set to 0 and do not affect the convolution operation, and thus may be omitted in an actual calculation.

Next, in operation S20, while traversing the spatial domain of the input tensor of the convolution operation with starting from the initial position, the computing system 100 repeatedly performs a process of obtaining an input patch having the same width and height as those of the output tensor at each position, and obtaining an output tensor corresponding to each unit filter via a convolution operation of the unit filter at a position corresponding to the position of the input patch and the input patch. In this regard, the traversal means a traversal of a stride having a size of 1. The coordinates on the spatial domain of an initial element of the input patch may be the same as the coordinates on the spatial domain of the unit filter defined in the spatial domain of the filter of the convolution operation.

In this regard, the convolution operation of operation S20 may be performed using a matrix multiplication operation.

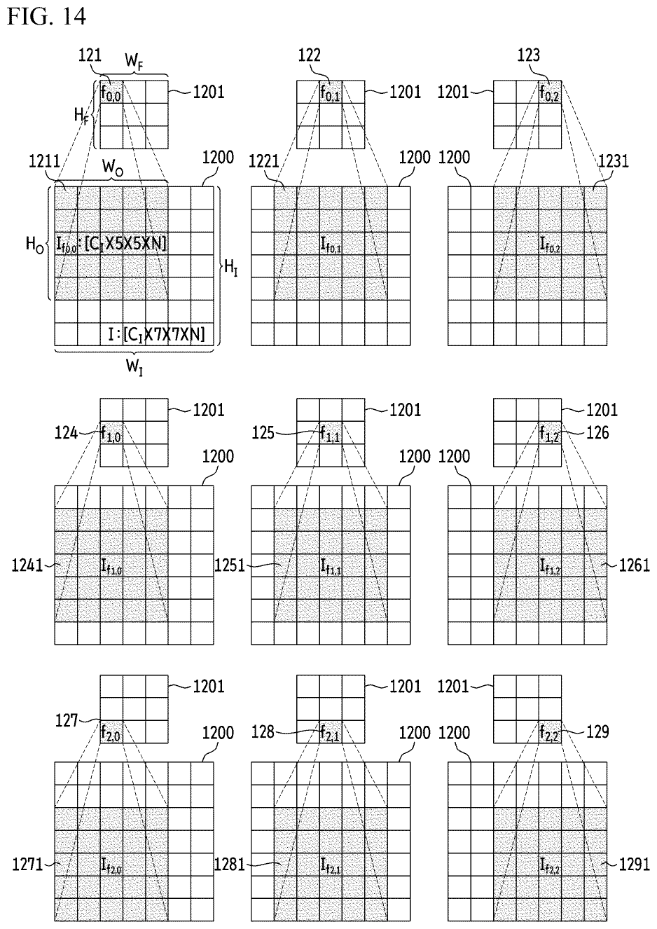

For example, referring to FIG. 14, the stride of the convolution operation is 1 (H_{S}=W_{S}=1). In this case, in order to perform the convolution operation of the filter tensor F 1201 and the input tensor I 1200, the computing system 100 divides the filter tensor F 1201 into the unit filters f 121, 122, 123, 124, 125, 126, 127, 128, and 129, each having the 1×1 size, and performs the matrix multiplication operation between each of the unit filters f 121, 122, 123, 124, 125, 126, 127, 128, and 129 and each of the input patches I_{f} 1211, 1221, 1231, 1241, 1251, 1261, 1271, 1281, and 1291, each having the same size as that of the output tensor O in the space domain of the input tensor I 1200, at each traversal position.

In a specific example, in FIG. 14, the computing system 100 may perform a convolution operation of a first unit filter f_{0,0} 121 and a first input patch I_{f}_{_{0,0}} 1211 at a first traversal position of the input tensor I 1200, and may perform a convolution operation of a second unit filter f_{0,1} 122 and a second input patch f_{0,1} 1221 at a second traversal position thereof. Subsequently, the computing system 100 may perform a convolution operation of a third unit filter f_{0,2} 123 and a third input patch I_{f}_{_{0,2}} 1231 at a third traversal position thereof, and perform a convolution operation of a fourth unit filter f_{1,0} 124 and a fourth input patch I_{f}_{_{1,0}} 1241 at a fourth traversal position thereof. In this manner, the traversal position is shifted by one stride to complete the traversal across the entire spatial domain of the input tensor I. Thus, the output tensor 121, 122, 123, 123, 124, 125, 126, 127, 128, and 129 corresponding to each unit filter is obtained as a result of the convolution operation on each of the nine unit filters 121, 122, 123, 124, 125, 126, 127, 128, and 129.

According to the above embodiment, using the GEMM matrix multiplication operation module as component of the high-performance optimized BLAS library, the convolution operation is converted into the matrix multiplication operation which in turn is executed, thereby increasing the operation speed.

In order to perform the GEMM-based matrix multiplication operation in operation S20, the data of the input tensor should be in the form of the packed tensor in which the data of the input tensor is consecutively stored in the memory. However, the input tensor is often not a packed tensor. Thus, a process of packing the data of the input patch to be subject to the matrix multiplication operation together with the unit filter in the memory in a form in which the data is able to be subject to the GEMM-based matrix multiplication operation is required.

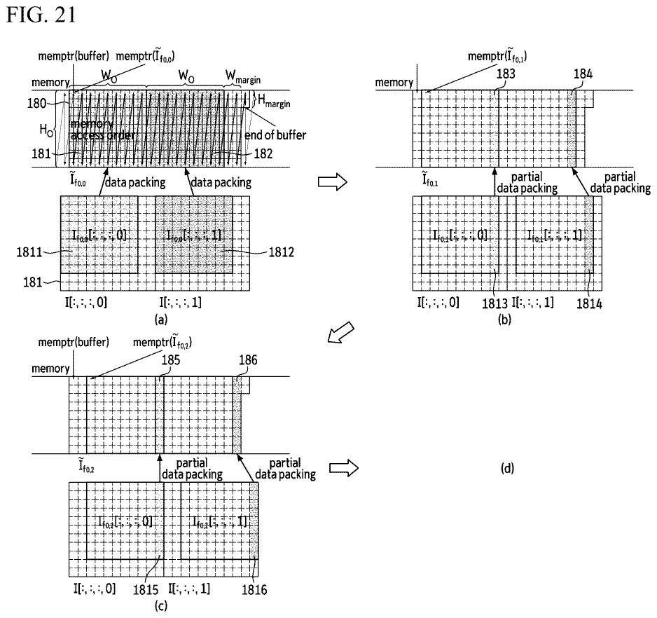

This data packing process will be described separately with reference to FIGS. 21 to 24.

Finally, in operation S30, the computing system 100 generates an output tensor of the convolution operation by accumulating the output tensors corresponding to the unit filters obtained in operation S20. That is, the computing system 100 may generate the output tensor of the convolution operation by repeatedly performing obtaining the output tensor corresponding to each unit filter in operation S20 and then accumulating the output tensors corresponding to the unit filters at a time in operation S30. In this regard, the use of the memory may be slightly increased, whereas there is an advantage in that parallel processing is easy.

However, the accumulation of the output tensors corresponding to the unit filters in operation S30 may be included in a process of repeatedly performing the acquisition of each of the output tensors corresponding to each of the unit filters in operation S20. In this regard, it may be difficult to perform the parallel processing, compared to the scheme of obtaining all output tensors corresponding to the unit filters and then accumulating all output sensors at once, while there is an advantage in that the memory usage is small.

Therefore, the scheme of accumulating the output tensors corresponding to the unit filters may be selectively applied in consideration of the memory availability of the system and whether parallel processing is possible.

According to the method according to the embodiment of the present disclosure as described above, in performing the convolution operation, the operation speed may be dramatically improved via the GEMM-based matrix multiplication operation using the unit filter of a minimum size.

FIG. 12 is a flowchart illustrating a method for performing a convolution operation according to another embodiment of the present disclosure.

The method for performing the convolution operation according to an embodiment of the present disclosure may be executed by the computing system 100 illustrated in FIG. 36. The computing system 100 may be, for example, the device for performing a convolution operation 1 illustrated in FIG. 35. The computing system 100 for executing the method according to the present embodiment may be a computing device having an application program execution environment. The computing system 100 may be, for example, a device capable of performing an operation function, such as a PC, a server, a laptop computer, and a smartphone.

It should be noted that the description of the subject of performing each of some operations included in the method according to embodiments of the present disclosure may be omitted, and in such a case, the subject is the computing system 100.

First, in operation S100, the computing system 100 converts a convolution operation having a stride of 2 or greater into a plurality of sub-convolution operations, each having a stride of 1.

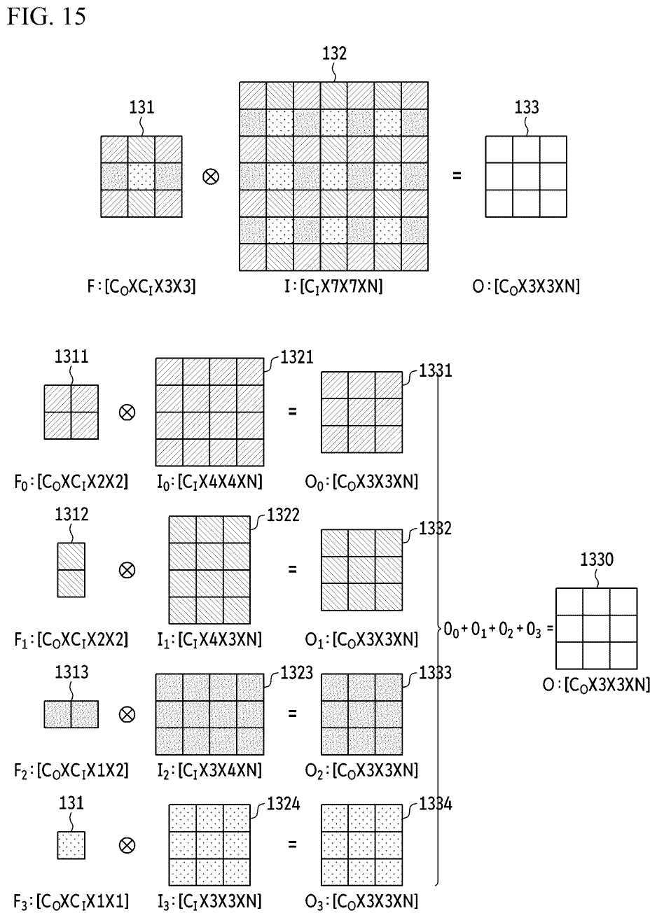

For example, referring to FIG. 15, in the convolution operation according to the related art, when a convolution operation having a stride of 2 is performed on a filter tensor F 131 having a size [C_{O}×C_{I}×3×3] and an input tensor I 132 having a size [C_{I}×7×7×N], an output tensor O 133 having a size [C_{O}×3×3×N] may be obtained.

In order to apply the method for performing a convolution operation according to an embodiment of the present disclosure, as illustrated in FIG. 15, the computing system 100 may divide a convolution operation in which a stride on the filter tensor F 131 and the input tensor I 132 is 2 into four sub-convolution operations, each sub-convolution operation having a stride of 1.

In this regard, each of the four sub-convolution operations include a convolution operation of each of the four sub-filters F₀, F₁, F₂, and F₃ 1311, 1312, 1313, and 1314 and each of the four sub-input tensors I₀, I₁, I₂, and I₃ 1321, 1322, 1323, and 1324.

In an embodiment, in performing operation S100, the plurality of sub-convolution operations may have different sub-filters having spatial domain sizes H×W (H and W are height and width, respectively) different from each other. For example, in FIG. 15, it may be identified that the size of the first sub-filter F₀ 1311 is 2×2, the size of the second sub-filter F₁ 1 1312 is 2×1, the size of the third sub-filter F₂ 1313 is 1×2, and the size of the fourth sub-filter F₃ 1314 is 1×1.

In this regard, a case in which the sizes of the spatial domains of the plurality of sub-filters are different from each other in the plurality of sub-convolution operations has been described by way of example. However, embodiments of the present disclosure are not limited thereto, and the spatial domains pf some of the plurality of sub-filters may have the same size.

In one example, each of the plurality of sub-convolution operations may have a sub-input tensor having a size corresponding to the spatial domain size of the sub-filter. In this regard, the size of the sub-input tensor may be determined based on the spatial domain size of the sub-filter so that the spatial domain size of the output tensor of the sub-convolution operation is equal to the spatial domain size of the output tensor of the convolution operation.

In an example, in the example of FIG. 15, the size of each of the four sub-input tensors I₀, I₁, I₂, and I₃ 1321, 1322, 1323, and 1324 may be determined using the size of each of the four sub-filters F₀, F₁, F₂, and F₃ 1311, 1312, 1313, and 1314 such that the size of each of the output tensors O₀, O₁, O₂, and O₃ 1331, 1332, 1333, and 1334 of the four sub-convolution operations is equal to the size 3×3 of the output tensor of the convolution operation.

In addition, in performing operation S100, the sub-filter of each of the plurality of sub-convolution operations may not be duplicate with the sub-filter of each of the others sub-convolution operations on the spatial domain of the filter of the convolution operation, and the sub-input tensor of each of the plurality of sub-convolution operations may not be duplicate with the sub-input tensor of each of the other sub-convolution operations on the spatial domain of the input tensor of the convolution operation.

For example, in the example of FIG. 15, it may be identified that the spatial domains of the four sub-filters F₀, F₁, F₂, and F₃ 1311, 1312, 1313, and 1314 into which the filter tensor F 131 divides are duplicate with each other on the spatial domain of the filter tensor F 131. Similarly, it may be identified that the spatial domains of the four sub-input tensors I₀, I₁, I₂, and I₃ 1321, 1322, 1323, and 1324 are not duplicate with each other on the spatial domain of the input tensors 1132.

Next, in operation S200, the computing system 100 divides the sub-filter of the sub-convolution operation having the size H_{F}×W_{F} of the spatial domain (each of H_{F} and W_{F} is a natural number of 2 or greater) into a plurality of unit filters, each unit filter having the spatial domain size of 1×1. However, the sub-filter in which H_{F}=W_{F}=1 may be interpreted as a unit filter. Thus, the process of dividing this unit filter is excluded.

Next, in operation S300, while traversing from the initial position of the spatial domain of the sub-input tensor of the sub-convolution operation, the computing system 100 repeats obtaining an input patch having the same width and height as those of the output tensor at each position, and obtaining an output tensor corresponding to each unit filter as a result of the convolution operation of the input patch and the unit filter of a position corresponding to the position of the input patch.

Next, in operation S400, the computing system 100 generates an output tensor of the sub-convolution operation by accumulating the output tensors respectively corresponding to the unit filter as obtained in operation S300.

Next, in operation S500, the computing system 100 repeatedly performs operation S200, operation S300, and operation S400 on each of the remaining sub-convolution operations.

Operations S200 to S500 is described based on the example of FIG. 15 as follows: in order to perform each of the four sub-convolution operations, the computing system 100 may divide each of the four sub-filters F₀, F₁, F₂, and F₃ 1311, 1312, 1313, and 1314 into a plurality of unit filters, each having a size of 1×1.

In this regard, the first sub-filter F₀ may be divided into four unit filters, the second sub-filter F₁ may be divided into two unit filters, and the third sub-filter F₂ may be divided into two unit filters. The fourth sub-filter F₃ has a size of 1×1, and thus may be a unit filter and thus not be subject to the division.

Subsequently, in the example of FIG. 15, in order to perform each of the four sub-convolution operations, while traversing the spatial domain of each of the four input tensors I₀, I₁, I₂, and I₃, 1321, 1322, 1323, and 1324 from the initial position, the computing system 100 may obtain an input patch having the same size as that of the output tensor at each position, and may perform a convolution operation of the obtained input patch and the unit filter of the position corresponding to the position of the obtained input patch, thereby obtaining an output tensor corresponding to each unit filter.

In this regard, the computing system 100 may generate the output tensors 1331, O₁, O₂, and O₃ 1331, 1332, 1333, and 1334 of the four sub-convolution operations by accumulating the output tensors respectively corresponding to the unit filters of each of the four sub-filters F₀, F₁, F₂, and F₃ 1311, 1312, 1313, and 1314.

Finally, in operation S600, the computing system 100 generates an output tensor of the convolution operation by summing the respective output tensors of the sub-convolution operations.

In the example of FIG. 15, the computing system 100 may obtain a final output tensor O 1330 via an operation of summing the output tensors O₀, O₁, O₂, and O₃, 1331, 1332, 1333, and 1334 respectively generated through the four sub-convolution operations, each sub-convolution operation having a stride of 1.

In this regard, it may be identified that the final output tensor O 1330 obtained using the four sub-convolution operations, each having a stride of 1, is the same as the output tensor O 133 obtained by a convolution operation having a stride of 2 according to the related art.

As described above, according to the method according to the embodiment of the present disclosure, not only when the convolution operation in which the stride is 1 is performed, but also when the convolution operation in which the stride is 2 or greater is performed, the operation speed may be improved via the GEMM-based matrix multiplication operation using the unit filter, and the memory usage may be reduced by removing the redundancy of data.

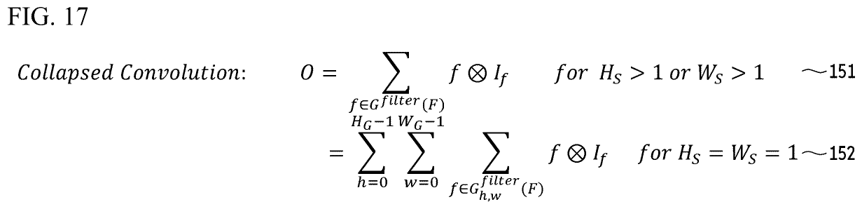

The convolution operation in which the stride is 2 or greater as described above with reference to FIG. 15 may be defined based on a Mathematical Formula expressed in FIG. 17. Referring to FIG. 17, the convolution operation 151 in which the stride is greater than 1 (H_{S}>1 or W_{S}>1) may be converted 152 into the plurality of sub-convolution operations, each having the stride of 1 (H_{S}=W_{S}=1), which in turn may be performed individually.

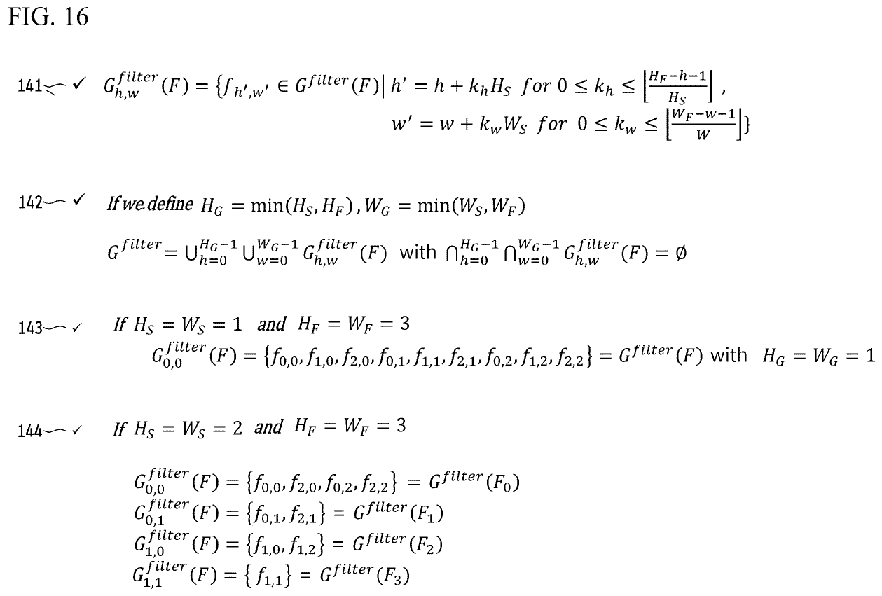

In this regard, a group of sub-filters of each of the plurality of sub-convolution operations may be defined based on a Mathematical Formula 141 of FIG. 16, and a filter tensor of the convolution operation before being converted into the plurality of sub-convolution operations may be expressed based on a Mathematical Formula 142 using the sub-filters.

For example, in FIG. 15, when a group of elements of the filter tensor F 131 of the convolution operation (each element is an element value of each of coordinates constituting a spatial domain of the filter tensor F 131) is defined as G^{filter}(F)={f_{0,0}, f_{1,0}, f_{2,0}, f_{0,1}, f_{1,1}, f_{2,1} f_{0,2}, f_{1,2}, f_{2,2}}) 143, a group of elements of each of the sub-filters F₀, F₁, F₂, and F₃ 1311, 1312, 1313, and 1314 of the plurality of sub-convolution operations may be defined as G^{filter}(F₀)={f_{0,0}, f_{2,0}, f_{0,2}, f_{2,2}}, G^{filter}(F₁)={f_{0,1}, f_{2,1}} G^{filter}(F₂)={f_{1,0}, f_{1,2}}, G^{filter}(F₃)={f_{1,1}} 144.

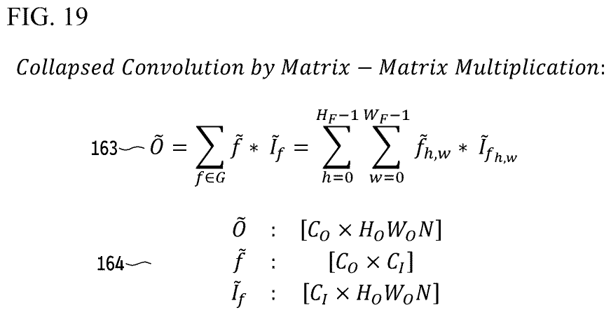

FIG. 19 is a diagram illustrating a Mathematical Formula of a convolution operation using a matrix multiplication operation of a unit filter and an input patch according to some embodiments of the present disclosure.

Referring to FIG. 19, a convolution operation (also referred to as Collapsed Convolution) according to an embodiment of the present disclosure may be expressed based on a Mathematical Formula 163 using a matrix multiplication operation of a unit filter and an input patch. In this regard, each of the output tensor Õ, the unit filter \tilde{f}, and the input patch Ĩ_{f} is converted into a form 164 of a two-dimensional matrix which is able be subject to a matrix multiplication operation.

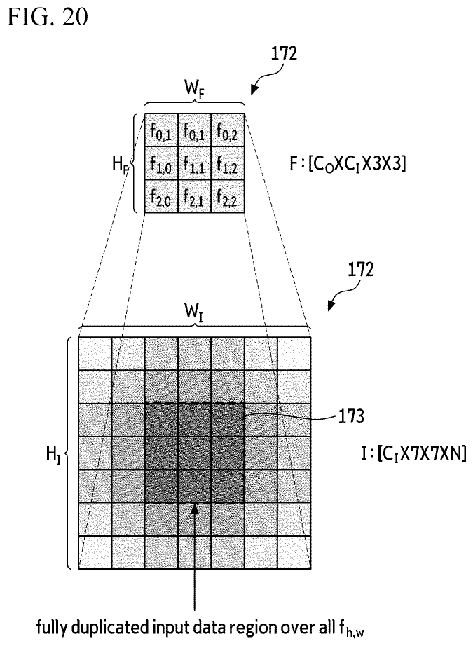

FIG. 20 is an example illustrating a domain of an input tensor in which redundant data references occur in a convolution operation according to some embodiments of the present disclosure.

In the illustrated example, in the in convolution operation in which H_{I}=W_{I}=7, H_{F}=W_{F}=3, H_{S}=W_{S}=1, a plurality of input patches I_{f} obtained while traversing the spatial domain of the input tensor I 172 using the respective unit filters f of the filter tensor F 171 include duplicate data domains of the input tensor I 172. This data duplication phenomenon occurs when the size of the spatial domain of the filter is larger than the size of the stride (i.e., it H_{F}>H_{S} or W_{F}>H_{S}), and is generally given as H_{F}=W_{F}>H_{S}=W_{S} in most applications using the convolution operation.

When data packing is performed in the memory without considering the redundancy of the data, the redundant data is stored separately in different physical spaces, thereby resulting in an unnecessarily high memory usage. In addition, since the same data is accessed at different physical locations of the memory, there is a problem in that cache utilization may be lowered and performance may be deteriorated.

Accordingly, a data packing method for dealing with the duplication of the input data in the convolution operation according to an embodiment of the present disclosure will be described below with reference to FIGS. 21 to 24.

FIGS. 21 to 23 are examples illustrating a data packing method for an GEMM-based matrix multiplication operation according to some embodiments of the present disclosure.

The data packing process to be described below may be applied when performing the operation S20 of the method for performing the convolution operation of FIG. 11 described above or the operation S300 of FIG. 12.

First, for data packing for data deduplication, the computing system 100 may allocate a tensor packing region as a separate region from an region in which the input tensor I is loaded on the memory. In this regard, the computing system 100 may obtain the input patch I_{f} from the allocated tensor packing region, and may store the obtained input patch I_{f} in a consecutive memory address so as to be accessible. That is, the data of the input patch I_{f} may be loaded into a memory address consecutive to the start address in the tensor packing region.

In an embodiment, in the process of obtaining the input patch while traversing the spatial domain of the input tensor of the convolution operation from the initial position, the computing system 100 may obtain new packing target data according to the traversal from a memory region in which the input tensor has been loaded, and pack the obtained new packing target data in the tensor packing region.

In a specific example of the data packing process according to an embodiment of the present disclosure, FIGS. 21 to 23 illustrate a scheme of storing data of each input patch in a tensor packing region in order to perform a matrix multiplication operation of each unit filter and each input patch as obtained while traversing a spatial domain of an input tensor of a convolution operation. In this regard, FIGS. 21 to 23 illustrate a case in which a batch size is 2. However, embodiments of the present disclosure is not limited thereto, and a case in which the batch size is 3 or greater may be applied in the same manner. In addition, parallel processing may be applied when performing a convolution operation via partitioning according to an batch size.

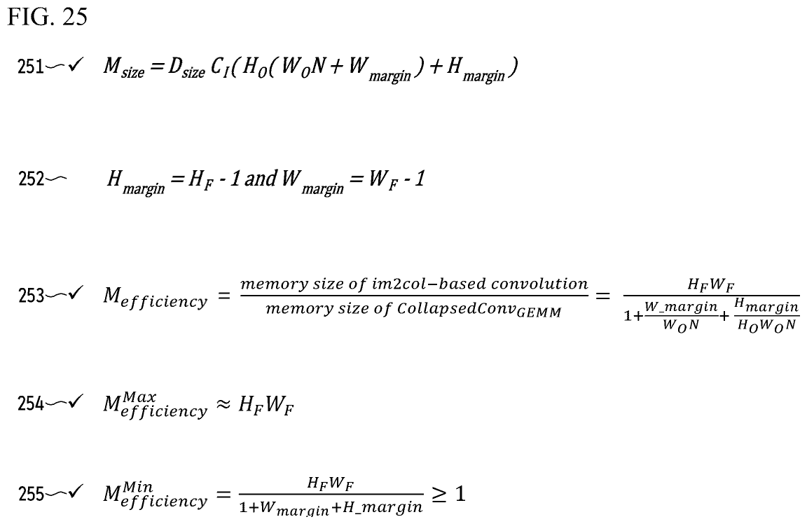

First, in (a) in FIG. 21, the computing system 100 allocates a tensor packing region 180 on a memory. In this regard, a memory buffer size M_{size} (see reference numeral 251 in FIG. 25) of the tensor packing region 180 may be determined in consideration of the size of the spatial domain of the output tensor, and may include an additional margin region W_{margin} and H_{margin} (see reference numeral 252 in FIG. 25). When the tensor packing region 180 has been allocated on the memory, the computing system 100 may perform data packing by copying and storing an entirety of data of a first input patch I_{f}_{_{0,0}} 1811 and 1812 obtained at a first traversal position on the spatial domain of the input tensor 181 into a first region 181 and 182 of the tensor packing region 180 (this data packing scheme is referred to as a tensor copy operation (Tensor_Copy)). In this regard, a start address memptr(Ĩ_{f}_{_{0,0}}) of the memory of the tensor packing region in which the data of the first input patch I_{f}_{_{0,0}} 1811 and 1812 is copied and stored is the same as a start address memptr(buffer) of the tensor packing region 180, and the data of the first input patch I_{f}_{_{0,0}} 1811 and 1812 is stored into from the start address memptr(Ĩ_{f}_{_{0,0}}) of the memory of the tensor packing region to an address consecutive thereto, in the order from top to bottom and from left to right. The input patch may have a form in which the input patch is able to be subject to the matrix multiplication operation with respect to with the unit filter.

Next, in (b) in FIG. 21, the computing system 100 may perform data packing by copying and storing new data 1813 and 1814 which is not duplicate with the first input patch 1811 and 1812 of the (a) in FIG. 21, among data of a second input patch I_{f}_{_{0,1}} 1812 obtained at a second traversal position on the spatial domain I_{f}_{_{0,0}} of the input tensor 181 into a second region 183 and 184 of the tensor packing region 180. In this regard, a start address memptr(Ĩ_{f}_{_{0,1}}) of the memory of the tensor packing region in which the data of the second input patch I_{f}_{_{0,1}} is stored is determined as an address obtained by applying a memory offset offset_{0,1} to the start address memptr(buffer) of the memory of the tensor packing region. In this regard, the memory offset may be calculated using a Mathematical Formula offset_{h,w}=D_{size}C_{I}(h+H_{O}w). In this regard, D_{size}ΔV denotes a memory size of a data element. In FP16, D_{size}=2 byte. In FP32, D_{size}=4 byte. In FP64, D_{size}=8 byte. The start address memptr(I_{f}_{_{0,1}}) of the memory in which the data of the second input patch Ĩ_{f}_{_{0,1}} is stored may be set as Set_Adress(Ĩ_{f}_{_{0,1}}, memptr(buffer)+offset_{0,1}) to generate a packed tensor. In this regard, the packed tensor refers to a tensor in which elements are consecutively stored in the memory in the order of the channel size C, the height H, the width W, and the batch size N in a column-major layout scheme.

Accordingly, the data of the second input patch I_{f}_{_{0,1}} is in a form of a packed tensor in which the data is stored in from the start address memptr(Ĩ_{f}_{_{0,1}}) to an address consecutive thereto of the memory, and is able to be subject to a matrix multiplication operation with respect to the unit filter.

In this regard, the start address memptr (Ĩ_{f}_{_{0,1}}) of the memory of the second input patch I_{f}_{_{0,1}} is obtained by shifting the start address memptr(I_{f}_{_{0,0}}) of the memory of the first input patch I_{f}_{_{0,0}} by one column in a width (W_{O}) direction. Required data except for the data of the last (W_{O}− 1)-th column is already stored in the memory of the tensor packing region via the packing process of the first input patch I_{f}_{_{0,0}}. That is, all data corresponding to the second input patch I_{f}_{_{0,1}} are already copied to the memory of the tensor packing region in the previous packing process of the first input patch I_{f}_{_{0,0}}. Thus, the data packing of the second input patch I_{f}_{_{0,1}} is completed only by setting the memory of the first input patch I_{f}_{_{0,1}} to be shared. Accordingly, the data packing of the second input patch I_{f}_{_{0,1}} may be efficiently performed in such a manner that only data on the last (W_{O}−1)-th column is partially copied to the memory of the tensor packing region. As described above, the data already copied to the memory in the previous packing process among the data of the input patch can be reused, such that the tensor copy operation Tensor_Copy may be performed in a manner in which only data other than the previously copied data is partially copied to the memory.

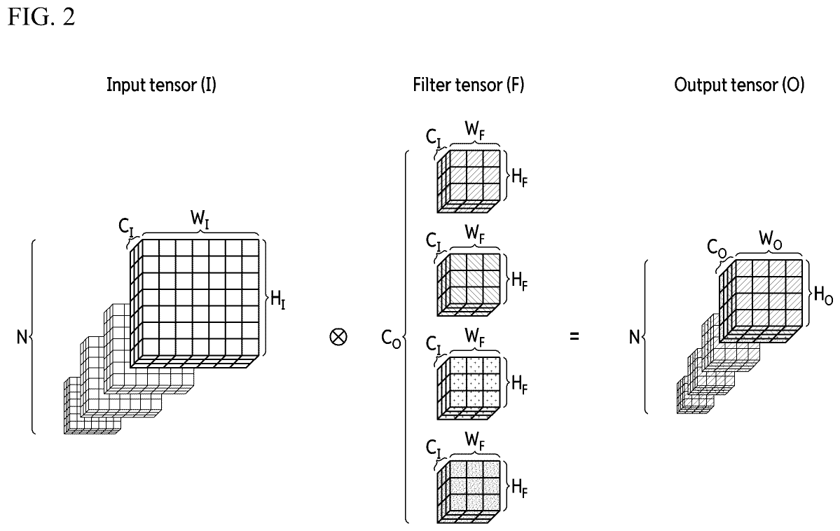

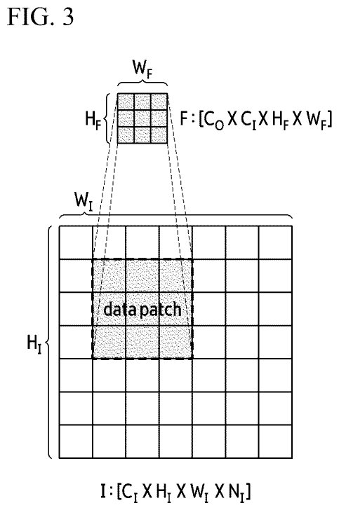

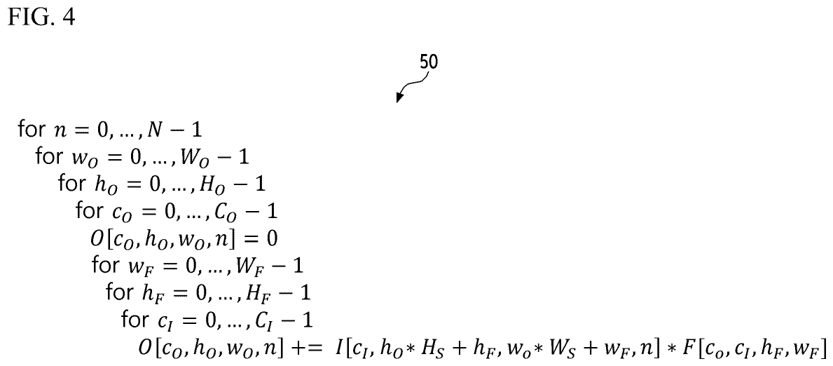

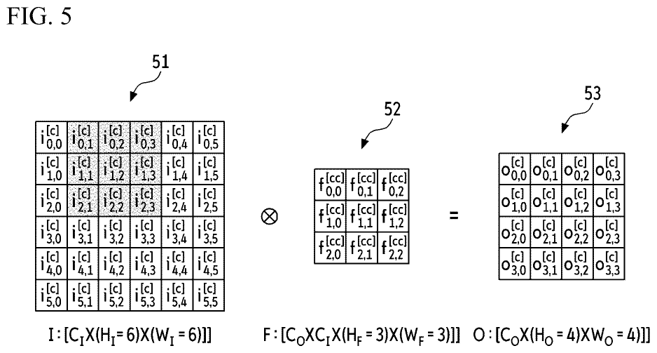

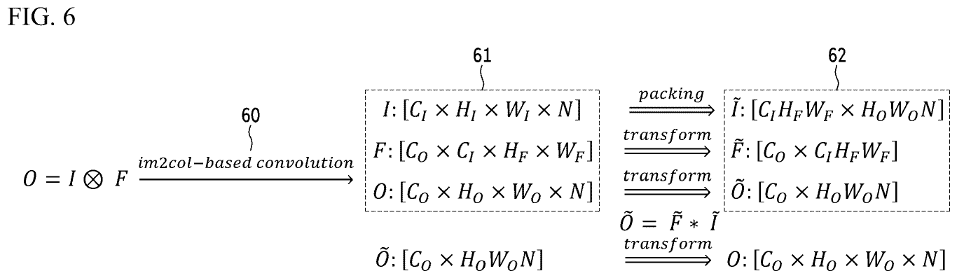

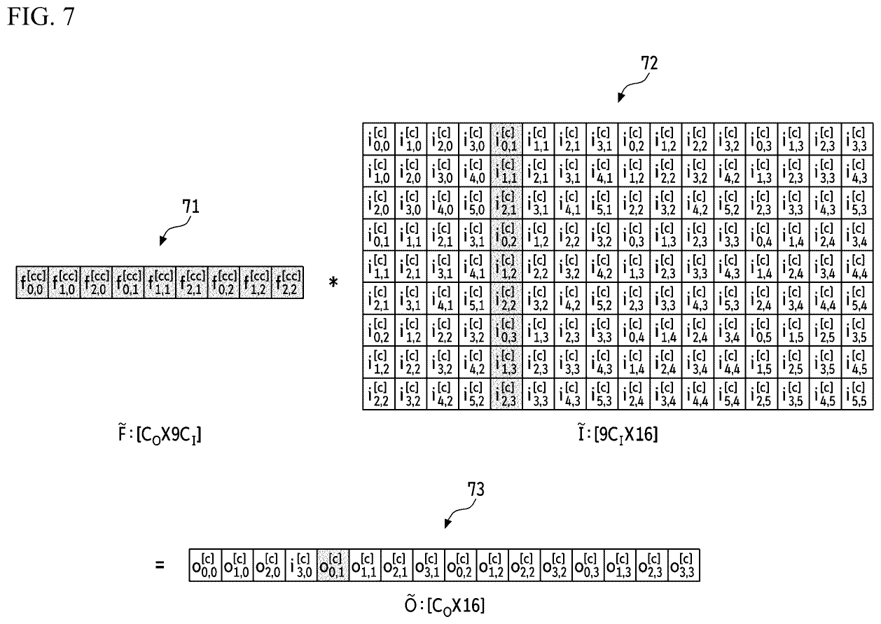

Next, referring to (c) in FIG. 21, the computing system 100 packs the data by copying and storing new data 1815 and 1816 that is not duplicate with the second input patch I_{f}_{_{0,1}} in the (b) in FIG. 2 among the data of the third input patch I_{f}_{_{0,2}} as obtained at a third traversal position on the spatial domain of the input tensor 181 to a third region 185 and 186 of the tensor packing region 180. In this regard, a start address memptr(Ĩ_{f}_{_{0,2}}) of the memory in which the data of the third input patch I_{f}_{_{0,2}} is obtained by applying a memory offset offset_{0,2} to the start address memptr(buffer) of the packing memory. For example, the start address memptr(Ĩ_{f}_{_{0,2}}) of the memory of the packed tensor Ĩ_{f}_{_{0,2}} in which the data of the third input patch I_{f}_{_{0,2}} may be set as Set_Address(Ĩ_{f}_{_{0,2}}, memptr(buffer)+offset_{0,2}).

Accordingly, the data of the third input patch I_{f}_{_{0,2}} is in a form of a packed tensor in which the data is stored into from the start address memptr(Ĩ_{f}_{_{0,2}}) to an address consecutive thereto of the memory, and is able to be subject to a matrix multiplication operation with respect to the unit filter.

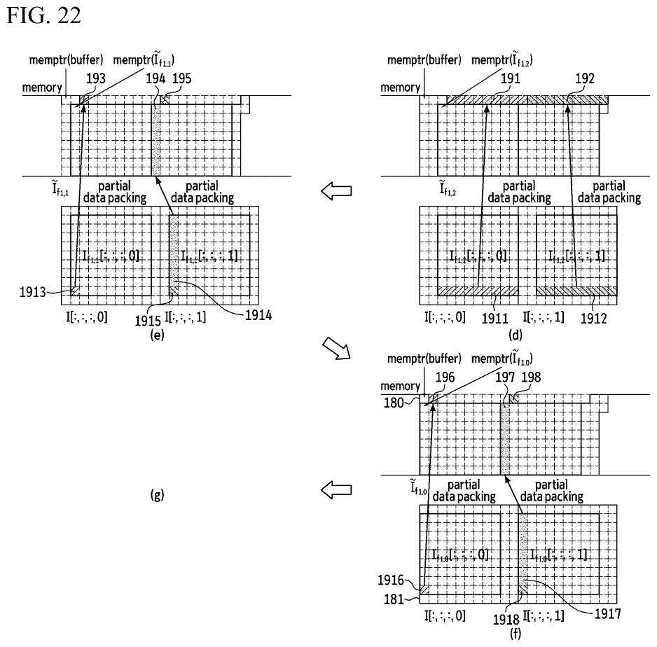

Next, in (d) FIG. 22, the computing system 100 packs the data by copying new data 1911 and 1912 that is not duplicate with the third input patch I_{f}_{_{0,2}} in (c) in FIG. 21 among data of a fourth input patch I_{f}_{_{1,2}} as obtained at a fourth traversal position on the spatial domain of the input tensor 181 to a fourth region 191 and 192 of the tensor packing region 180. In this regard, a start address memptr(Ĩ_{f}_{_{1,2}}) of the memory in which the data of the fourth input patch I_{f}_{_{1,2}} is stored is obtained by applying a memory offset offset_{1,2} to the start address memptr(buffer) of the packing memory. For example, the start address memptr(I_{f}_{_{1,1}}) of the memory of the packed tensor Ĩ_{f}_{_{1,2}} in which the data of the fourth input patch Ĩ_{f}_{_{1,2}} is stored may be set as Set_Address(Ĩ_{f}_{_{1,2}}, memptr(buffer)+offset_{1,2}).

Accordingly, the data of the fourth input patch I_{f}_{_{1,2}} is in a form of a packed tensor in which the data is stored into from the start address memptr(Ĩ_{f}_{_{1,2}}) to an address consecutive thereto of the memory, and is able to be subject to a matrix multiplication operation with respect to the unit filter.

Next, in (e) in FIG. 22, the computing system 100 packs the data by copying and storing new data 1913, 1914, and 1915 that is not duplicate with the fourth input patch I_{f}_{_{1,2}} in (d) in FIG. 22 among data of a fifth input patch I_{f}_{_{1,1}} as obtained at a fifth traversal position on the spatial domain of the input tensor 181 to a fifth region 193, 194, and 195 of the tensor packing region 180. In this regard, a start address memptr(I_{f}_{_{1,1}}) of the memory in which the data of the fifth input patch Ĩ_{f}_{_{1,1}} is stored is obtained by applying a memory offset offset_{1,1} to the start address memptr(buffer) of the packing memory. For example, the start address memptr(I_{f}_{_{1,1}}) of the memory of the packed tensor Ĩ_{f}_{_{1,1}} in which the data of the fifth input patch Ĩ_{f}_{_{1,1}} is stored may be set as Set_Address(Ĩ_{f}_{_{1,1}}, memptr(buffer)+offset_{1,1}).

Accordingly, the data of the fifth input patch I_{f}_{_{1,1}} is in a form of a packed tensor in which the data is stored into from the start address memptr(Ĩ_{f}_{_{1,1}}) to an address consecutive thereto of the memory, and is able to be subject to a matrix multiplication operation with respect to the unit filter.

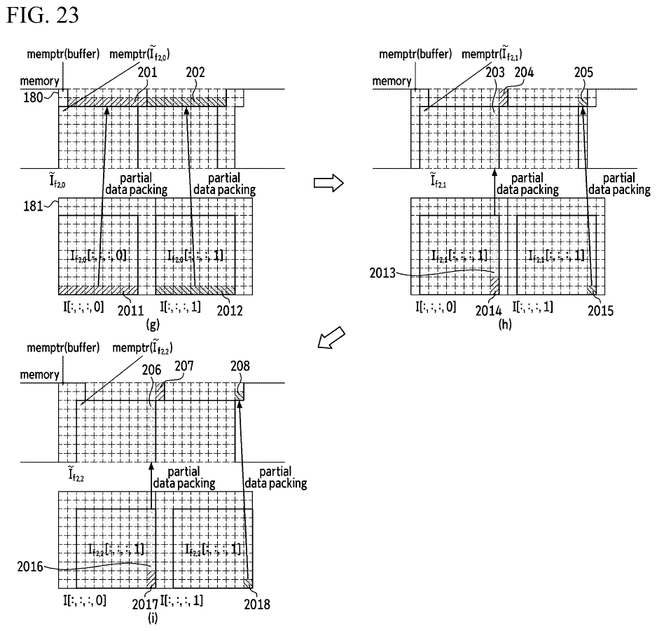

In this manner, the data packing process from (a) in FIG. 21 to (i) in FIG. 23 may be sequentially performed.

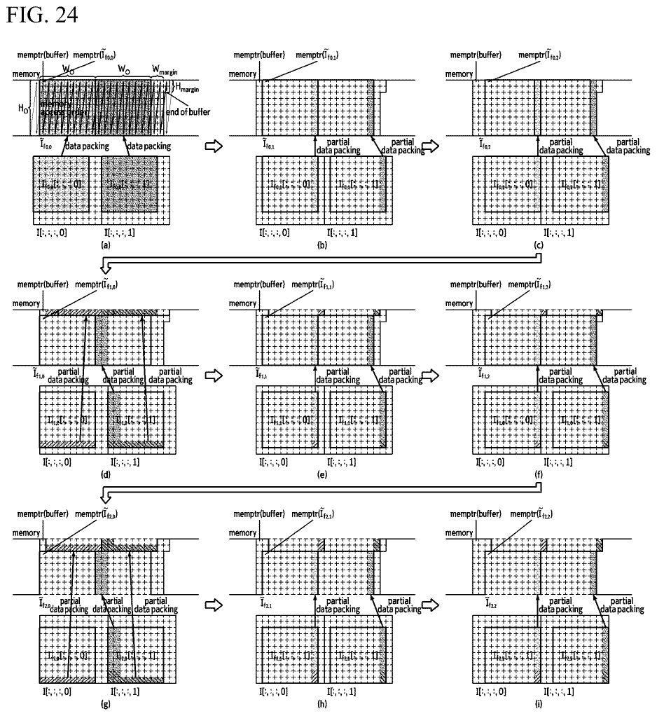

FIG. 24 illustrates a data packing method having a traversal direction different from that of the example of FIGS. 21 to 23. Except that only the traversal direction in FIG. 24 is different from that of FIGS. 21 to 23, the same principle of packing the new data of the input patch not stored at the previous traversal position into the consecutive addresses on the tensor packing region may be applied thereto.

According to the above-described embodiment, a packing procedure of copying all data of an input patch only during an initial convolution operation is performed, and then, in data packing of an input patch of a subsequent convolution operation, memory data copied in the previous process may be reused. Thus, only the partial data in place of the entire data of the input tensor may be copied and packed, thereby remarkably increasing the efficiency of using the memory.

Referring to FIG. 25, a size M_{size} of the memory buffer of the tensor packing region allocated on the memory by the computing system 100 may be determined using a Mathematical Formula 251.

In addition, as expressed in the Mathematical Formula 251, the tensor packing region may further include an additional margin region in addition to a region corresponding to the size of the spatial domain of the output tensor. A size H_{margin} and W_{margin} of the margin region may be determined using a Mathematical Formula 252, and in the Mathematical Formula 252, N means the batch size.

According to an embodiment of the present disclosure, when the data packing is performed using the tensor packing region allocated on the memory as described above, the memory use efficiency M_{efficiency} compared to that in the conventional IM2COL-based convolution algorithm may be calculated as in a Mathematical Formula 253.

In this regard, when the H_{O}, W_{O}, or batch size N of the output tensor is significantly larger than each of W_{margin} and H_{margin} such that

$$\frac{{W}_{margin}}{{W}_{O} N} \approx 0 , \frac{{H}_{margin}}{{H}_{O} {W}_{O} N} \approx 0 ,$$

the maximum memory usage efficiency

$${M}_{efficiency}^{Max}$$

may be expressed based on a Mathematical Formula 254. When W_{O}=H_{O}=1, N=1, the minimum memory usage efficiency

$${M}_{efficiency}^{Min}$$

of the convolution operation according to the embodiment of the present disclosure compared to that in the IM2COL-based convolution operation algorithm may be expressed based on a Mathematical Formula 255.

That is, the convolution operation according to the embodiment of the present disclosure has a common feature with the IM2COL-based convolution operation algorithm in that a high-performance GEMM function is applied thereto. However, the convolution operation according to the embodiment of the present disclosure is superior, in most of general convolution operation environments, to the IM2COL-based convolution operation algorithm in terms of memory usage efficiency.

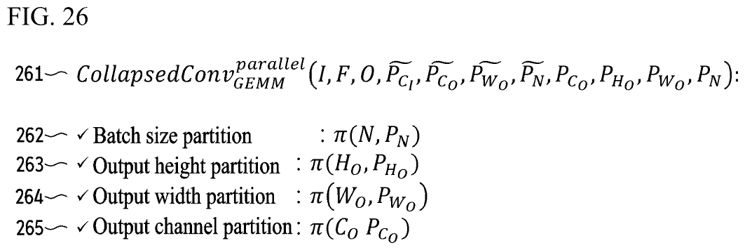

FIG. 26 is an example of partitioning for parallelization according to some embodiments of the present disclosure.

In an embodiment, in performing operation S20 of FIG. 11, the computing system 100 may divide at least one of a batch size 262 of a convolution operation 261, a spatial domain height 263 of the output tensor of the convolution operation 261, a spatial domain width 264 of the output tensor of the convolution operation 261, and an output channel 265 of the convolution operation 261 into a plurality of partitions to construct a plurality of parallel processing tasks, and may perform parallel processing on the convolution operation 261 in various hardware environments using different operation means on some of the plurality of parallel processing tasks and the others thereof. For example, each of different operation means for performing parallel processing on the convolution operation may be, for example, CPU, MPU, CPU, NPU, TPU, or the like. In another example, each of the different operation means for performing parallel processing on the convolution operation may be, for example, each of different cores executed in one NPU.

Thus, parallel processing on the convolution operation may be performed by different hardware chips or may be performed by multi-cores included in one hardware chip.

According to the embodiment of the present disclosure as described above, tuning of GEMM performance and packing memory may be controlled via the partitioning of the convolution problem into small convolution problems.

The example of partitioning as described in FIG. 26 may be applied to the convolution operation algorithm according to the algorithm 13 of FIG. 35.

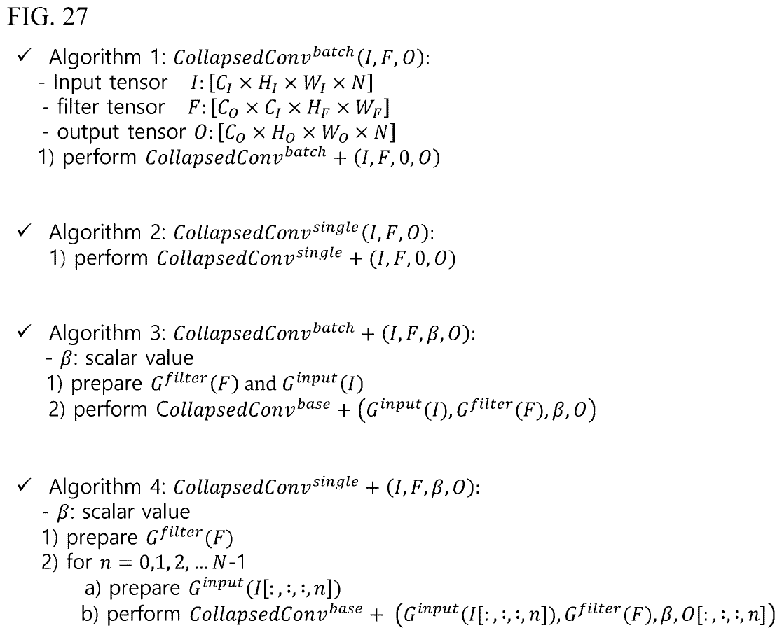

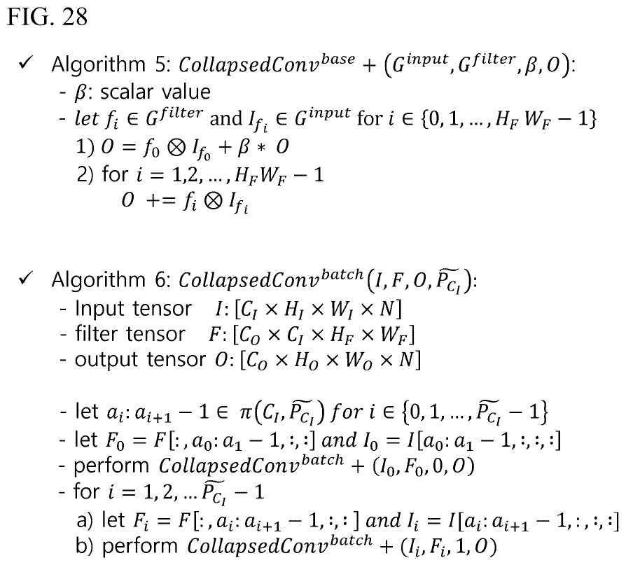

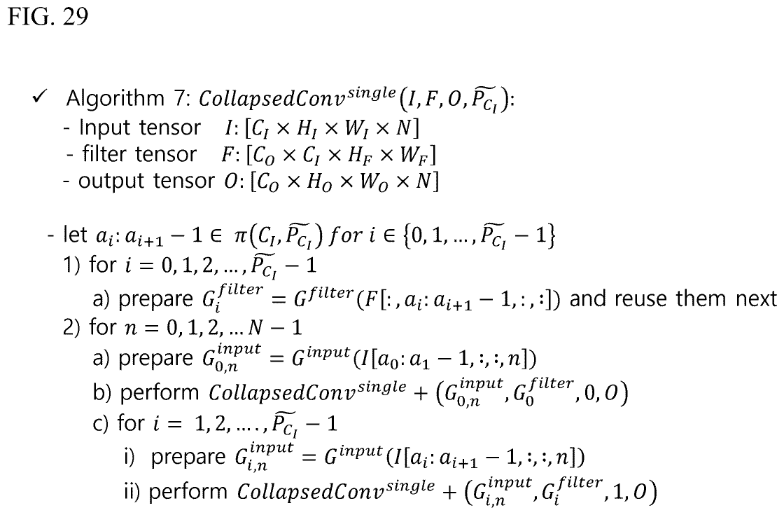

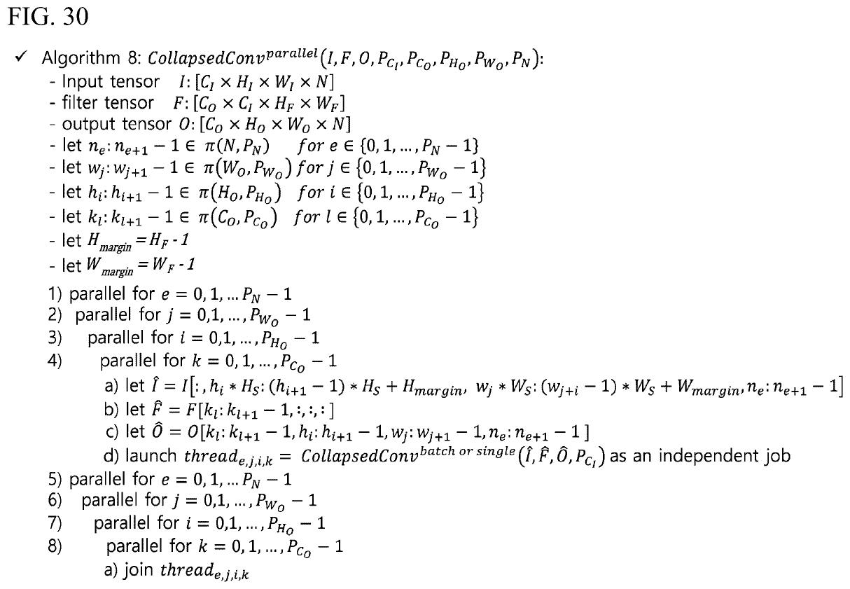

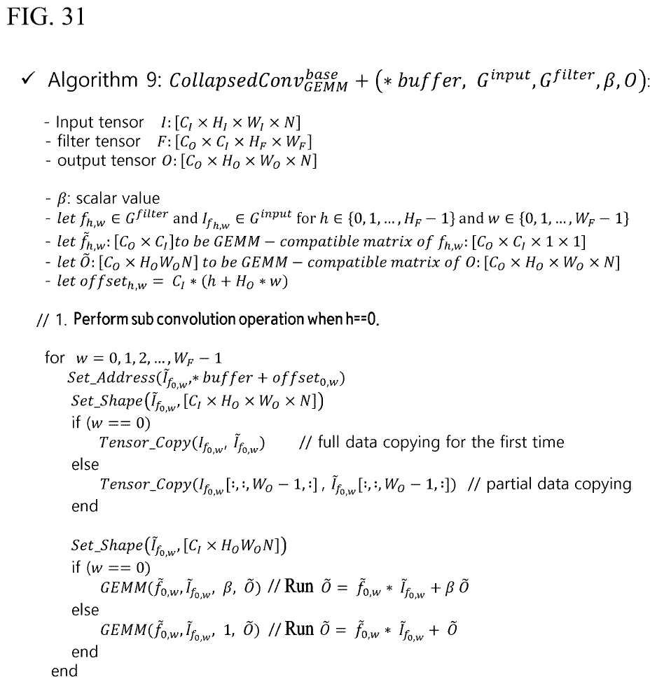

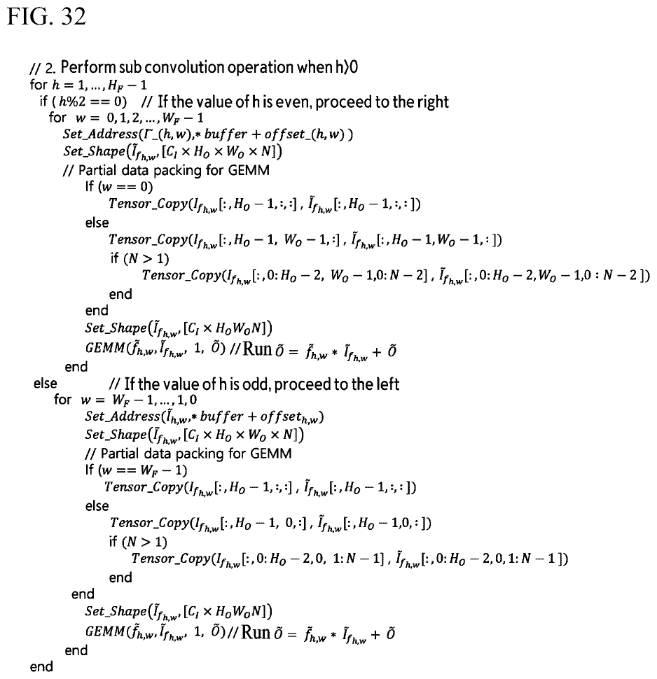

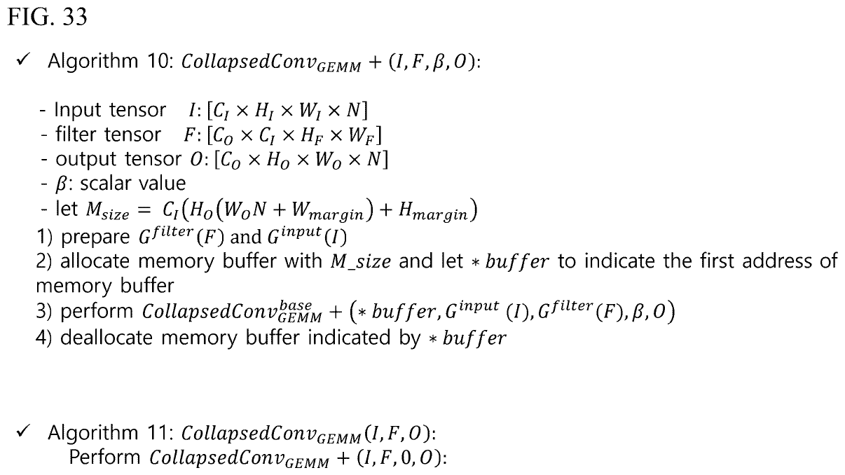

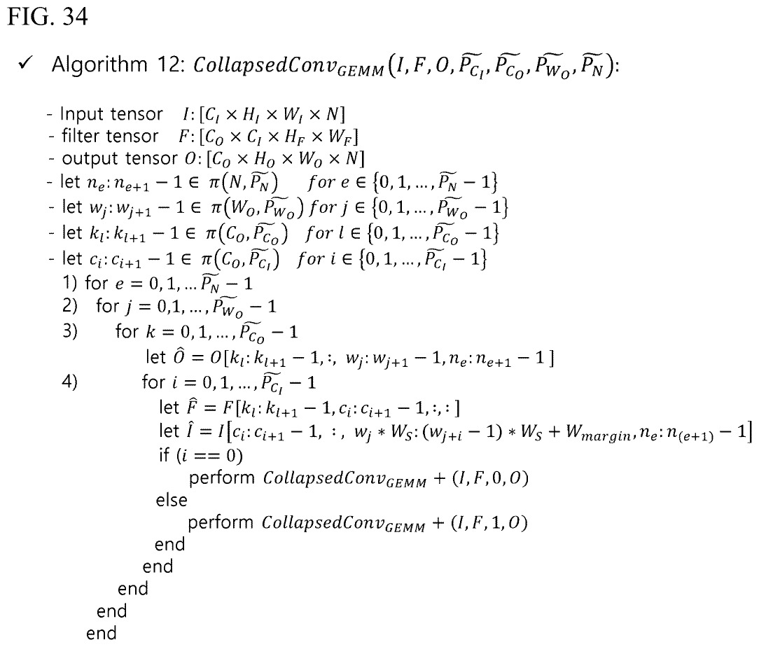

Hereinafter, FIGS. 27 to 35 show various embodiments of convolution operation algorithms according to some embodiments of the present disclosure.

Among the various convolution operation algorithms, Algorithm 1 is an example of a convolution operation of a batch version that processes all data samples at once, and Algorithm 2 is an example of a convolution operation that processes a convolution operation on a single data sample basis.

Algorithms 3 to 5 are examples of an algorithm that performs the convolution operation and then accumulates the operation results.

Algorithm 6 and Algorithm 7 are examples of a convolution operation considering partitions of the input channel, and Algorithm 8 is an example of performing parallel processing of the convolution operation via partitioning of the batch size, output height, output width, and output channel.

In addition, Algorithms 9 to 11 are examples of processing a convolution operation via the above-described data packing method, and Algorithm 12 is an example of a method of dividing the convolution operation into a plurality of smaller convolution operations via partitioning of a batch size, an output width, an output channel, and an input channel, and performing the plurality of smaller convolution operations and then accumulating the operation results.

Finally, Algorithm 13 is an example of performing a GEMM-based convolution operation parallelized and optimized by a plurality of operation devices and threads via hierarchical partitioning using algorithm 8 and algorithm 12.

According to the embodiment of the present disclosure as described above, during a convolution operation, memory usage may be reduced and cache efficiency may be improved via efficient memory reuse and data redundancy removal. In addition, using the optimized GEMM function, the operation speed is greatly increased. Providing an additional parallelization opportunity may allow the efficient parallel operation to be possible in various hardware environments. Accordingly, the convolution operation method and device may be optimized to effectively operate in an environment in which memory and computing resources are limited such as mobile and embedded systems.

In addition, when the convolution operation according to the embodiment of the present disclosure is applied, implementation complexity is lowered using a consistent operation structure and a standardized BLAS library operation, such that maintenance is easy. In addition, the convolution operation method and device may be easily applied to various models and application fields via flexible kernel size and parameter setting.

FIG. 37 is a hardware configuration diagram of an exemplary computing system 100.

Referring to FIG. 37, the computing system 100 may include one or more processors 101, a bus 107, a network interface 102, a memory 103, which loads a computer program 105 executed by the processors 101, and a storage 104 for storing the computer program 105.

The processor 101 controls overall operations of each component of computing device 100. The processor 101 may be configured to include at least one of a Central Processing Unit (CPU), a Micro Processor Unit (MPU), a Micro Controller Unit (MCU), a Graphics Processing Unit (GPU), or any type of processor well known in the art. Further, the processor 101 may perform calculations on at least one application or program for executing a method/operation according to various embodiments of the present disclosure. The computing system 100 may have one or more processors.

The memory 103 stores various data, instructions and/or information. The memory 103 may load one or more programs 105 from the storage 104 to execute methods/operations according to various embodiments of the present disclosure. An example of the memory 103 may be a RAM, but is not limited thereto.

The bus 107 provides communication between components of computing system 100. The bus 107 may be implemented as various types of bus such as an address bus, a data bus and a control bus.

The network interface 102 supports wired and wireless internet communication of the computing system 100. The network interface 102 may support various communication methods other than internet communication. To this end, the network interface 102 may be configured to comprise a communication module well known in the art of the present disclosure.

The storage 104 can non-temporarily store one or more computer programs 105. The storage 104 may be configured to comprise a non-volatile memory, such as a Read Only Memory (ROM), an Erasable Programmable ROM (EPROM), an Electrically Erasable Programmable ROM (EEPROM), a flash memory, a hard disk, a removable disk, or any type of computer readable recording medium well known in the art.

The computer program 105 may include one or more instructions, on which the methods/operations according to various embodiments of the present disclosure are implemented. When the computer program 105 is loaded on the memory 103, the processor 101 may perform the methods/operations in accordance with various embodiments of the present disclosure by executing the one or more instructions.

In some embodiments, the computing system 100 as described with reference to FIG. 37 may be configured using one or more physical servers included in a server farm based on a cloud technology such as a virtual machine. In this regard, at least some of a processor 101, a memory 103, and storage 104 among the components illustrated in FIG. 37 may be virtual hardware, and a network interface 102 may also be embodied as a virtualized networking element such as a virtual switch.

According to an embodiment, the computer program 105 may include instructions for dividing a filter of a convolution operation having a spatial domain size H_{F}×W_{F} into a plurality of unit filters, each unit filter having a spatial domain size of 1×1, wherein each of H_{F} and W_{F} is a natural number of 2 or greater; while traversing a spatial domain of an input tensor of the convolution operation from an initial position thereof, repeating: i) obtaining an input patch having a size of H_{O}×W_{O} at a current position according to a result of the traversing, wherein W_{O} is a width of a spatial domain of an output tensor of the convolution operation, and H_{O} is a height of the spatial domain of the output tensor of the convolution operation; and ii) obtaining an output tensor corresponding to each unit filter as a result of a convolution operation between the obtained input patch and a unit filter of a position corresponding to a position of the obtained input patch; and accumulating the obtained output tensors respectively corresponding to the unit filters, thereby generating the output tensor of the convolution operation.

According to an embodiment, the computer program 105 may include instructions for converting a convolution operation having a stride of 2 or greater into a plurality of sub-convolution operations, each sub-convolution operation having a stride of 1; dividing a sub-filter of one of the sub-convolution operations having a spatial domain size H_{F}×W_{F} into a plurality of unit filters, each unit filter having a spatial domain size of 1×1, wherein each of H_{F} and W_{F} is a natural number of 2 or greater; while traversing a spatial domain of a sub-input tensor of the one of the sub-convolution operations from an initial position thereof, repeating: i) obtaining an input patch having a size of H_{O}×W_{O} at a current position according to a result of the traversing, wherein W_{O} is a width of a spatial domain of an output tensor of the one of the sub-convolution operations, and H_{O} is a height of the spatial domain of the output tensor of the one of the sub-convolution operations; and ii) obtaining an output tensor corresponding to each unit filter as a result of a convolution operation between the obtained input patch and a unit filter of a position corresponding to a position of the obtained input patch; accumulating the obtained output tensors respectively corresponding to the unit filters, thereby generating the output tensor of the one of the sub-convolution operations; repeating the dividing of the filter, the repeating of the i) and ii), and the generating of the output tensor, on each of the remaining sub-convolution operations; and summing the output tensors of all of the sub-convolution operations to generate an output tensor of the convolution operation.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation.

What is claimed is:

1. A method for performing a convolution operation, the method being performed by a computing system, the method comprising:
dividing a filter of a convolution operation having a spatial domain size H_{F}×W_{F} into a plurality of unit filters, each unit filter having a spatial domain size of 1×1, wherein each of H_{F} and W_{F} is a natural number of 2 or greater;
while traversing a spatial domain of an input tensor of the convolution operation from an initial position thereof, repeating:
i) obtaining an input patch having a size of H_{O}×W_{O} at a current position according to a result of the traversing, wherein W_{O} is a width of a spatial domain of an output tensor of the convolution operation, and H_{O} is a height of the spatial domain of the output tensor of the convolution operation; and
ii) obtaining an output tensor corresponding to each unit filter as a result of a convolution operation between the obtained input patch and a unit filter of a position corresponding to a position of the obtained input patch; and
accumulating the obtained output tensors respectively corresponding to the unit filters, thereby generating the output tensor of the convolution operation.

2. The method of claim 1, wherein coordinates on a spatial domain of an initial element of the input patch is the same as coordinates on the spatial domain of the unit filter defined within the spatial domain of the filter of the convolution operation.

3. The method of claim 1, wherein the traversal has a stride of a size 1.

4. The method of claim 1, wherein the dividing of the filter includes:
when a dilation of the convolution operation is 2 or greater, generating a dilated filter using the filter of the convolution operation; and
dividing the dilated filter into the plurality of unit filters.

5. The method of claim 1, wherein the repeating of the i) and the ii) includes:
obtaining the input patch in a tensor packing region on a memory of the computing system,
wherein the tensor packing region is different from and non-duplicate with a memory region into which the input tensor of the convolution operation has been loaded,
wherein data of the input patch is loaded into from a start address to a memory address consecutive thereto in the tensor packing region in a form of a packed tensor.

6. The method of claim 5, wherein the convolution operation may is performed using a GEMM operation of a basic linear algebra subprograms (BLAS) library.

7. The method of claim 5, wherein the obtaining of the input patch includes:
obtaining new packing target data according to the traversal from the memory region into which the input tensor has been loaded; and
packing the new packing target data into the tensor packing region.

8. The method of claim 7, wherein the tensor packing region is a buffer region having a size of D_{size}C_{I}(H_{O}(W_{O}N+W_{margin})+H_{margin}),
wherein D_{size} denotes a memory size of a data element, and H_{margin}=H_{F}−1 and W_{margin}=W_{F}−1,
wherein H_{F} denotes a height on a spatial domain of a filter of the convolution operation, and W_{F} denotes a width on the spatial domain of the filter of the convolution operation.

9. The method of claim 1, wherein the repeating of the i) and the ii) includes:
constructing a plurality of parallel processing tasks, based on at least one of dividing an batch size of the convolution operation into a plurality of first partitions, dividing a spatial domain height of the output tensor of the convolution operation into a plurality of second partitions, dividing a spatial domain width of the output tensor of the convolution operation into a plurality of third partitions, and dividing an output channel of the convolution operation into a plurality of fourth partitions; and
performing some of the plurality of parallel processing tasks using a first operation means, and performing the others of the plurality of parallel processing tasks using a second operation means.

10. A method for performing a convolution operation, the method being performed by a computing system, the method comprising:
while traversing a spatial domain of an input tensor of a convolution operation from an initial position thereof, obtaining an input patch having a size H_{O}×W_{O} at each position according to a result of the traversing, wherein the spatial domain of the input tensor has H_{I}×W_{I}, wherein each of H_{I} and W_{I} is a natural number of 1 or greater, wherein W_{O} denotes a width of a spatial domain of an output tensor of the convolution operation, and H_{O} denotes a height of the spatial domain of the output tensor of the convolution operation, wherein the input patch is obtained from a tensor packing region on a memory of the computing system;
obtaining new packing target data non-duplicate with data of an input patch obtained at a previous traversal from a memory region into which the input tensor has been loaded, at each position according to a result of the traversing; and
packing the new packing target data into the tensor packing region,
wherein the tensor packing region is different from and non-duplicate with the memory domain into which the input tensor of the convolution operation has been loaded,
wherein the data of the input patch is loaded into from a start address to an address consecutive thereto in the tensor packing region in a form of a packed tensor.

11. A method for performing a convolution operation, the method being performed by a computing system, the method comprising:
converting a convolution operation having a stride of 2 or greater into a plurality of sub-convolution operations, each sub-convolution operation having a stride of 1;
dividing a sub-filter of one of the sub-convolution operations having a spatial domain size H_{F}×W_{F} into a plurality of unit filters, each unit filter having a spatial domain size of 1×1, wherein each of H_{F} and W_{F} is a natural number of 2 or greater;
while traversing a spatial domain of a sub-input tensor of the one of the sub-convolution operations from an initial position thereof, repeating:
i) obtaining an input patch having a size of H_{O}×W_{O} at a current position according to a result of the traversing, wherein W_{O} is a width of a spatial domain of an output tensor of the one of the sub-convolution operations, and H_{O} is a height of the spatial domain of the output tensor of the one of the sub-convolution operations; and
ii) obtaining an output tensor corresponding to each unit filter as a result of a convolution operation between the obtained input patch and a unit filter of a position corresponding to a position of the obtained input patch;
accumulating the obtained output tensors respectively corresponding to the unit filters, thereby generating the output tensor of the one of the sub-convolution operations;
repeating the dividing of the filter, the repeating of the i) and ii), and the generating of the output tensor, on each of the remaining sub-convolution operations; and
summing the output tensors of all of the sub-convolution operations to generate an output tensor of the convolution operation.

12. The method of claim 11, wherein the plurality of sub-convolution operations have respective sub-filters having different spatial domain sizes.

13. The method of claim 12, wherein each of the plurality of sub-convolution operations has a sub-input tensor having a size corresponding to the spatial domain size of the sub-filter,
wherein the size of the sub-input tensor is determined based on the spatial domain size of the sub-filter such that a spatial domain size of the output tensor of the sub-convolution operation is equal to a spatial domain size of the output tensor of the convolution operation.

14. The method of claim 12, wherein a sub-filter of each of the plurality of sub-convolution operations is non-duplicate with a sub-filter of each of the other sub-convolution operations on a spatial domain of a filter of the convolution operation,
wherein a sub-input tensor of each of the plurality of sub-convolution operations is non-duplicate with a sub-input tensor of each of the other sub-convolution operations on a spatial domain of an input tensor of the convolution operation.
